(19) United States
(12) Patent Application Publication
(10) Pub. No.: US 2013/0124266 A1
(43) Pub. Date: May 16, 2013

(54) SYSTEMS, METHODS, AND PROGRAM PRODUCTS FOR INNOVATION FINANCE

(71) Applicants: Brennan Klose, Washington, DC (US); Urban Ramstedt, Bethesda, MD (US); Leslie A. Platt, Reston, VA (US); Elizabeth G. Malloy, Bethesda, MD (US); Geoffrey G. White, Guilford, CT (US); Philip Barton, Norwich, VT (US); Christina Hedberg, Bethesda, MD (US); Matthew G. Duchars, Gaithersburg, MD (US)

(72) Inventors: Brennan Klose, Washington, DC (US); Urban Ramstedt, Bethesda, MD (US); Leslie A. Platt, Reston, VA (US); Elizabeth G. Malloy, Bethesda, MD (US); Geoffrey G. White, Guilford, CT (US); Philip Barton, Norwich, VT (US); Christina Hedberg, Bethesda, MD (US); Matthew G. Duchars, Gaithersburg, MD (US)

(73) Assignee: Unither Virology, LLC

(21) Appl. No.: 13/529,799

(22) Filed: Jun. 21, 2012

Related U.S. Application Data
(60) Provisional application No. 61/499,810, filed on Jun. 22, 2011.

(51) Int. Cl. G06Q 10/06

(52) U.S. Cl. CPC G06Q 10/0637
USPC 705/7.36

(57) ABSTRACT

A funding method and system provides funding at all stages of product development and manufacture. One or more of the funding organizations are matched with one or more of the securities issuing entities, and one or more of the securities issuing entities are matched with one or more of the pathable development projects, based at least in part on projected financial return, a schedule of tranches for the stages of the pathable development project, and a surety arrangement. One or more of the securities purchasing entities are matched with one or more securities issuing entities.

### RELATED APPLICATIONS

This application claims priority to provisional patent application 61/499,810, entitled “Systems, Methods, and Program Products for Innovation Finance,” filed on Jun. 22, 2011, which is incorporated in its entirety herein by reference.

### FIELD OF INVENTION

The present invention generally relates to a system, method and program product for using a computer system to generate business deals to fund the research and development of innovative technology products, by using a distributed, networked computer system to integrate the elements of a deal from data provided by parties participating in the system; and to establish constructs, standards and protocols for the proper and efficient functioning of the system.

### BACKGROUND

One problem associated with the current approach to research and development funding is that it provides funding for discrete stages of a research and development timeline, which makes research planning and continuity difficult. Funding currently comes from individual sources that often do not communicate or exchange information or align regarding their goals or needs, so funding from each of these “vertical silos” cannot be aligned or aggregated to fund the entire research and development timeline in a continuous, efficient manner. Due to these drawbacks, there is limited certainty for researchers, funders, investors, and other stakeholders, which translates to delayed economic development and job growth and slowdowns in scientific advancement.

### SUMMARY OF THE INVENTION

According to one implementation, there is provided a method comprising:

accessing, using one or more computers, one or more databases on computer-readable storage media, comprising:
research and development organizations;
product development projects associated with respective of the research and development organizations;
funding organizations, and respective organization funding requirements including a technical readiness requirement for the respective product development project;
securities issuing entities, and respective issuing entity requirements;
securities purchasing entities with one or more securities purchase criteria;
pathable development projects, wherein a respective pathable project comprises a project with a timeline or path that comprises a plurality of development stages and milestones related to the development of a marketable product from one of the product development projects;

obtaining and storing over time, using the one or more computers, data for product development projects, research and development organizations; funding organizations, and respective organization requirements; securities issuing entities, and respective issuing entity requirements, securities purchasing entities, and pathable development projects;

determining or obtaining a respective technical readiness level for each of a plurality of the product development projects and storing, using the one or more computers, the respective technical readiness levels in the one or more databases;

determining or obtaining for each of a plurality of the product development projects, respective development stages and milestones for a respective pathable development project and one or more entities to perform the respective development stages;

determining, using the one or more computers, an estimated full or partial funding amount for respective of the pathable development projects;

determining in one or more matching steps one or more of:
matching, using the one or more computers, a respective one of the pathable development projects with one or more of the funding organizations, based at least in part on matching the organization requirements of the respective funding organization to one selected from the group of the technical readiness level of the product development project associated with the respective pathable development project, a target product profile, an amount of available funds for a given target product profile, an approximate timeframe for completion of the pathable development project, and a requested co-funding amount;
matching, using the one or more computers, one or more of the funding organizations with one or more of the securities issuing entities, based at least in part on the respective issuing entity requirements of the respective issuing entities relating to at least one selected from the group of jobs projected to be created by the respective pathable development project, location of work for the respective pathable development project, and technology type;
matching, using the one or more computers, one or more of the securities issuing entities with one or more of the pathable development projects, based at least in part on one selected from the group of a projected financial return, a schedule of tranches for the stages of the pathable development project, and a surety arrangement;
matching, using the one or more computers, one or more of the securities purchasing entities with one or more of the securities issuing entities, based at least in part on at least one selected from the group of level or percentage of funding relative to the funding amount for the respective pathable development project, a projected financial return, a schedule of tranches for the stages of the pathable development project, and a surety arrangement; and

determining, using the one or more computers, that a level or percentage of funding of the pathable development project is substantially complete relative to the full funding amount for the respective pathable development project or determining a gap in the level or percentage of funding of the pathable development project relative to the full funding amount for the respective pathable development project.

### BRIEF DESCRIPTION OF THE DRAWINGS

The above and related objects, features and advantages of the present invention, will be more fully understood by reference to the following detailed description of the exemplary embodiments of the present invention, when taken in conjunction with the following exemplary figures, wherein:

FIG. 1A is a schematic block diagram of an exemplary system in accordance with embodiments of the invention.

FIG. 1B is a schematic diagram of an exemplary input-output interface in accordance with embodiments of the invention.

FIG. 2A is a schematic block diagram of an exemplary system in accordance with embodiments of the invention.

FIG. 2B is a schematic block diagram of an exemplary method in accordance with embodiments of the invention.

FIG. 2C is a schematic block diagram of an exemplary method in accordance with embodiments of the invention.

FIG. 3 is a schematic block diagram of an exemplary configuration in accordance with embodiments of the invention.

FIG. 4 is a schematic flow chart of goals and contributions for exemplary embodiments of the invention.

FIG. 5 is a schematic block diagram of an exemplary configuration in accordance with embodiments of the invention.

FIG. 6 is a schematic block diagram of an exemplary configuration in accordance with embodiments of the invention.

FIG. 7 is a schematic block diagram of an exemplary method in accordance with embodiments of the invention.

FIG. 8A is a schematic diagram of an exemplary deal report in accordance with embodiments of the invention.

FIG. 8B is a schematic flow chart of an exemplary deal term arrangement in accordance with embodiments of the invention.

FIG. 9 is a flow chart of a method of financing a development project in accordance with an embodiment of the invention.

### DETAILED DESCRIPTION OF EMBODIMENTS

The present invention generally relates to systems, methods and, program products for creating and operating a computerized system to identify, align, match, track, report, audit, and conduct and create reports on project deals and comparative deal flow and other activities using an aligned and linked funding approach. In one or more embodiments, the system and method facilitates generation of business deals to fund the research and development of innovative technology products, by using a distributed, networked computer system to integrate the elements of a deal from data provided by participating parties.

In one or more embodiments, a computer system is used to align the financing of innovation to the actual Research & Development (R&D) process of innovation technology organizations, by means of calculating and facilitating bond-based financing deals to overcome vertical siloed barriers among funding organizations and achieve strategic continuity of funding aimed at delivering licensed, usable products.

In one or more embodiments, aligned financing deals may be generated using computerized logic to perform one or more of the following:
(1) Converting and applying grant and contract funds as debt service guarantees and payments, using private, foundation and government authorities (such as flexible grants and contracts, Other Transaction Authorities (OTA's), etc.) to provide debt service payments, pledges, and/or guarantees;
(2) Turning R&D funding sources and uses from vertical (based on funding organization boundaries, conditions, and limits) to horizontal (based on projects to perform a defined path of activities to deliver products);
(3) Matching funding sources with bond and other horizontal financing mechanisms;
(4) Mixing, matching and linking funding sources (e.g. public, private, NGO; total, partial) to align R&D financing with R&D science processes, stages and cycles;
(5) Establishing constructs, standards and protocols for linking initial strategic co-investment decisions and related due diligence to establish eligibility for (a) initial strategic investments; (b) funding throughout the length of the R&D process all the way to product availability; (c) after availability (including any required regulatory approvals, e.g. by FDA for biomedical products), potential funding of the acquisition and sustainability/maintenance of the innovative technology products, as well as potential funding of manufacturing facilities to produce the products;
(6) Calculating, establishing and aligning tranches of financing with science milestones;
(7) Using computer processing to identify, align, match, track, report, audit, conduct and create reports on project deals and comparative deal flow and other activities using the aligned and linked funding approach.

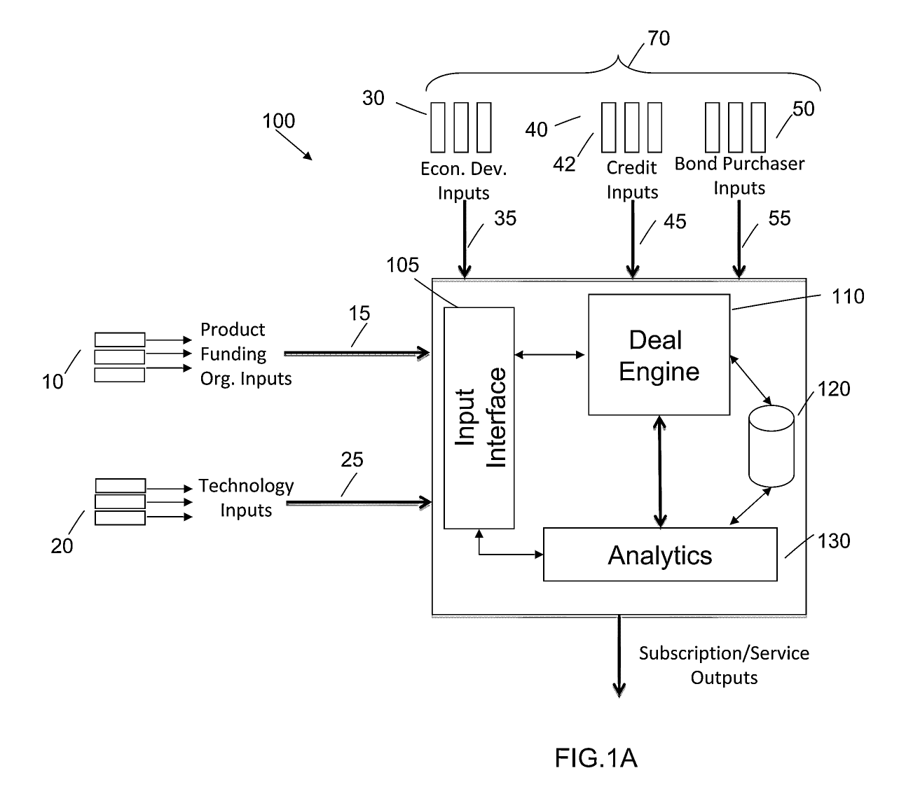

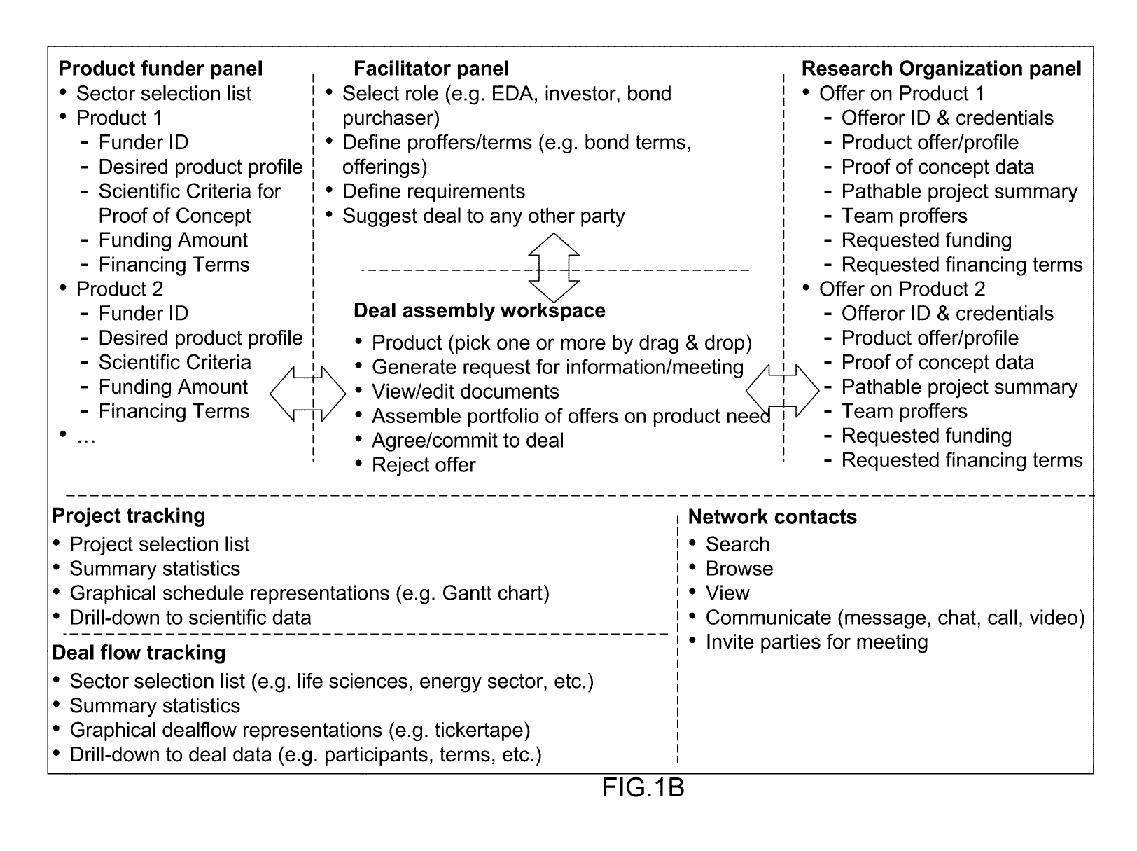

FIG. 1A illustrates an exemplary embodiment of a system 100 for facilitating and accelerating innovative project development R&D. The system comprises one or more computers, one or more databases, and various communications networks for receiving, storing, processing, and outputting data. The types of project development relates to so-called “pathable” projects that meet certain criteria for achieving a marketable end product. More specifically, pathable products have a general timeline or path that includes various development stages and milestones related to the development of a marketable product or technology that may be licensed. The stages, milestones, and final outcome may be specific to the particular research and development or industry, such that the timeline or path is tailored to the research and development to which it relates.

Inputs to system 100 generally include product funding organization inputs, research and development and/or technology development inputs, facilitator and/or bond issuer inputs, credit inputs, and bond purchaser inputs. Outputs from system 100 may include processed or unprocessed data based at least in part on the input data and may be specific to at least one request for data received by system 100.

Product funding organization inputs 15 generally relate to data on organizations and on the types of products and/or research and development they would like to promote by facilitating the issuance and purchase of bonds. For example, product funding organizations 10 may include organizations such as governmental agencies that have specific goals with respect to products that would help meet a public need, as well as private groups or foundations that are willing to provide similar support to further their own goals. These identified types of organizations are not intended to limit the scope of what a product funding organization may be, but merely provide illustrative examples for the purposes of the discussion herein. Product funding organization inputs 10 may also provide criteria related to the products the respective organization seeks to promote, along with a specified bond payment pledge or guarantee that would be made available to facilitate the product development. Alternatively, or in addition, the bond payment pledge or guarantee may be made available through other facilitation organizations, as will be discussed below, to research and development organizations that are developing products or technologies related to the product funding organization's goals and that meet the specified criteria. In an exemplary embodiment, these product funding organization inputs 15 may include product needs, scientific criteria to be satisfied, baseline financing terms, and the amount of debt service payment, pledge or guarantee provided. As mentioned previously, these product funding organizations 10 may be public federal agencies or organizations, such as the Department of Health and Human Services, Department of Defense, Department of Agriculture, government-sponsored entities, or may be private foundations or organizations, such as the Gates Foundation. An example data structure for product funding organization inputs in embodiments of the invention may comprise:

<Product Funding Organization Input>

<Product Needs>
<Scientific Criteria>
<Funding Amount>
<Financing Terms>

</Product Funding Organization Input>

Research and development and/or technology development inputs 25, such as pathable research and development for a potential marketable end product, may be provided by a plurality of entities 20 such as research and development organizations, universities, private research and development companies, or individuals and may be related to planned or current research and development. These examples of entities 20 that may provide technology development inputs are not intended to be limiting, and this group may be collectively referred to herein as “research and development organizations.” In one embodiment, technology inputs received from research and development entities relate to ongoing research and development that has been developed to a specific stage by the research and development entity. In one example, the research and development entity may have funded the past research and development with a combination of grant funding, loans, equity investments, debt investments, and/or other forms of financing. The research and development entity may have achieved a specified point with its research and development and may have satisfied certain criteria with its research and development, which enable the research and development entity to take advantage of the features of system 100 for further research and development funding. In an exemplary embodiment, these research and development and/or technology inputs 25 may include the type of product being researched, scientific data supporting a proof of concept (e.g., data supporting how a potential product can be manufactured and turn a profit), and a plan that includes stages with milestones for multiple of the stages, a path to the product or licensing arrangement, a timeline, cost of the path, and a business plan. An example data structure for research and/or technology development inputs 25 in embodiments of the invention may comprise:

<Research Development Input>
<Product Type= “Influenza Therapeutic”>
<Data= “Proof of Concept Data”>
<Plan>

<Stage Data>
<Milestone Data>
<Path Data>
<Timeline>
<Financial Data>
<Business Plan Data>
</Plan>
</Research Development Input>

Facilitators 70 may be organizations, finance institutions, economic development agencies, individuals, or any other type of organizations that are able to facilitate a funding opportunity between research and technology development organizations 20 and a product funding source 10. In embodiments, facilitators 70 may comprise economic developers 30, strategic investors 40, private-sector co-guarantors 42, or bond purchasers 50.

Economic development inputs 35 relate to potential funding opportunities and allow product funding organization inputs 15 to be aligned in various preliminary sub-matches with research and development and technology development inputs 25 to facilitate further technological development. Economic developers 30 may be organizations, finance institutions, economic development agencies, individuals, or any other type of organizations that are able to facilitate a funding opportunity between research and technology development organizations 20 and a product funding source 10 by issuing or facilitating the issuance of bonds. Economic developers generally have specific criteria regarding the types of innovation for which they would prefer to facilitate funding, with the exact criteria specific to the facilitator. For example, local economic development agency developers may have certain criteria related to local job creation and local investment. Research and technology development organizations that already have operations within the jurisdiction associated with the agency facilitator may be able to satisfy these criteria by expanding their existing operations. Organizations that do not already have a presence in the jurisdiction may qualify as well, for example, by agreeing to establish a presence within the jurisdiction so that it satisfies the criteria set forth by the economic development agency. In an exemplary embodiment, economic development agency inputs 35 may include geographical requirements to locate the operation, company suggestions for particular types of opportunities, job creation goals, financial proffers, and bonding authority. An example data structure for Economic Development inputs in embodiments of the invention may comprise:

<Economic Development Input>

<Geographic Requirements>
<Suggested Companies>

<Company 1: Technology, Size, Location>
. . .
<Company N: Technology, Size, Location>

</Suggested Companies>
<Job Creation Goals= “Jobs Data”>
<Financial Proffers= “Financial Data”>
<Bonding Authority>

</Economic Development Input>

Credit inputs 45 provide different information or services to facilitate a matching opportunity between product funding organizations 10 and research and technology organizations 20. In one embodiment, credit inputs comprise an equity investment from strategic investors 40. For example, strategic investors may provide an equity investment in a research and development organization 20 based on the research and development organization's current or future research and development. This investment may also satisfy a criteria specified by the product funding organization 10 or system 100 that allows the research and development organization 20 to qualify for funding opportunities using system 100. Equity inputs from strategic investors are generally direct equity investments made in the research and development organization by investors who are qualified to evaluate the nature of the technology and its relative merits. In some embodiments, equity investors 40 may include organizations associated with governmental agencies, such as DARPA or other funding agencies, and/or may be private investment organizations. Inputs from strategic investors may include types of technologies to be funded, types of financing offered, vetting credentials, and investment amounts. An example data structure for Credit inputs for embodiments of the invention may comprise:

<Credit Input>

<Product Types>
<Financing Types>
<Vetting Credentials>
<Investment Amount>

</Credit Input>

In some embodiments, credit inputs 45 may be received by system 100 from one or more private sector co-guarantors 42. Private sector co-guarantors 42 may be organizations or individuals who provide additional guarantees or pledges related to the guarantee or pledge provided by a product funding organization. In some embodiments, inputs from private sector co-guarantors may impact bond terms provided by one or more facilitators, as discussed previously, by providing an additional guarantee of a bond payment or pledge that allows the economic developers 30 to offer bonds to potential bond purchasers with more attractive terms. In one example, an input from a private sector co-guarantor may provide an additional guarantee related to bonds that are to be offered by a local economic development agency economic developer 30. The credit input 45 may also include a product interest of the private sector co-guarantor, which identifies the types of products or research and development it is willing to promote, as discussed previously with respect to product funding organizations. In an exemplary embodiment, inputs from private sector co-guarantors may include product interest, and monetary amounts that the entity is willing to pledge, and financing terms.

<Credit Input>

<Bond Guarantee>
<Product Interest>
<Monetary Amount>
<Financing Terms>

</Credit Input>

Bond purchaser inputs 55 are also forms of facilitator inputs 70 and may be received by system 100 from individual investors or organizations that express an interest in or provide a commitment to purchase bonds related to research and development being performed by research organizations. These inputs may include bond purchase terms, identification of particular tranches related to stages of an organization's research development path, and amounts that the purchaser is willing to buy through system 100. In an exemplary embodiment, inputs from bond purchasers include purchase terms, such as interest rates, monetary payment amounts, repayment schedules, and other bond-purchase terms (e.g. debt-to-equity conversion terms, warrants, etc.). An example data structure for bond purchaser inputs in embodiments of the invention may comprise:

<Bond Purchaser Input>

<Purchase Terms>

<Interest Rate>
<Payment Data>
<Additional Bond Terms>

</Purchase Terms>

</Bond Purchaser Input>

It should be noted that the method of obtaining the foregoing inputs is not limiting on the invention. For example, one or more of the inputs may be received electronically over a communications network. One or more inputs may also be received by mail, facsimile, or by telephone, or a during a meeting, and then entered or scanned electronically into system 100, or may comprise pulling the data from a database or other entity, or may comprise generating some of the data.

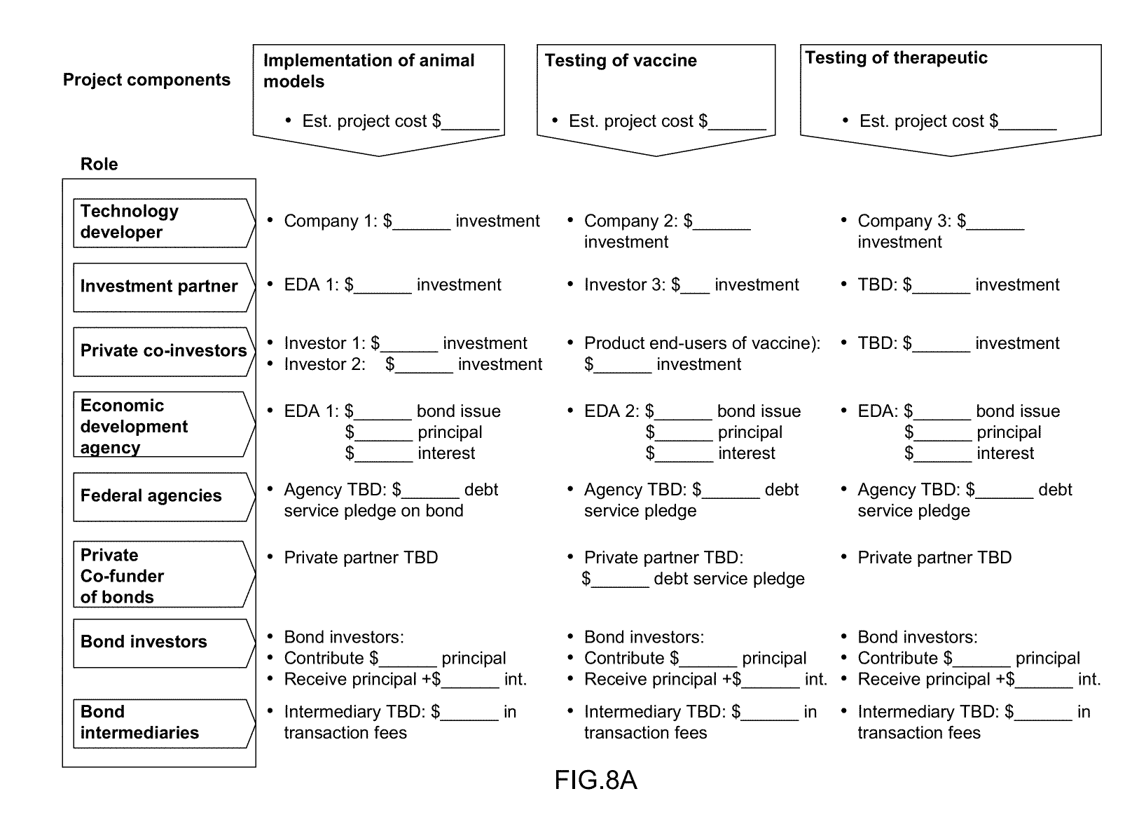

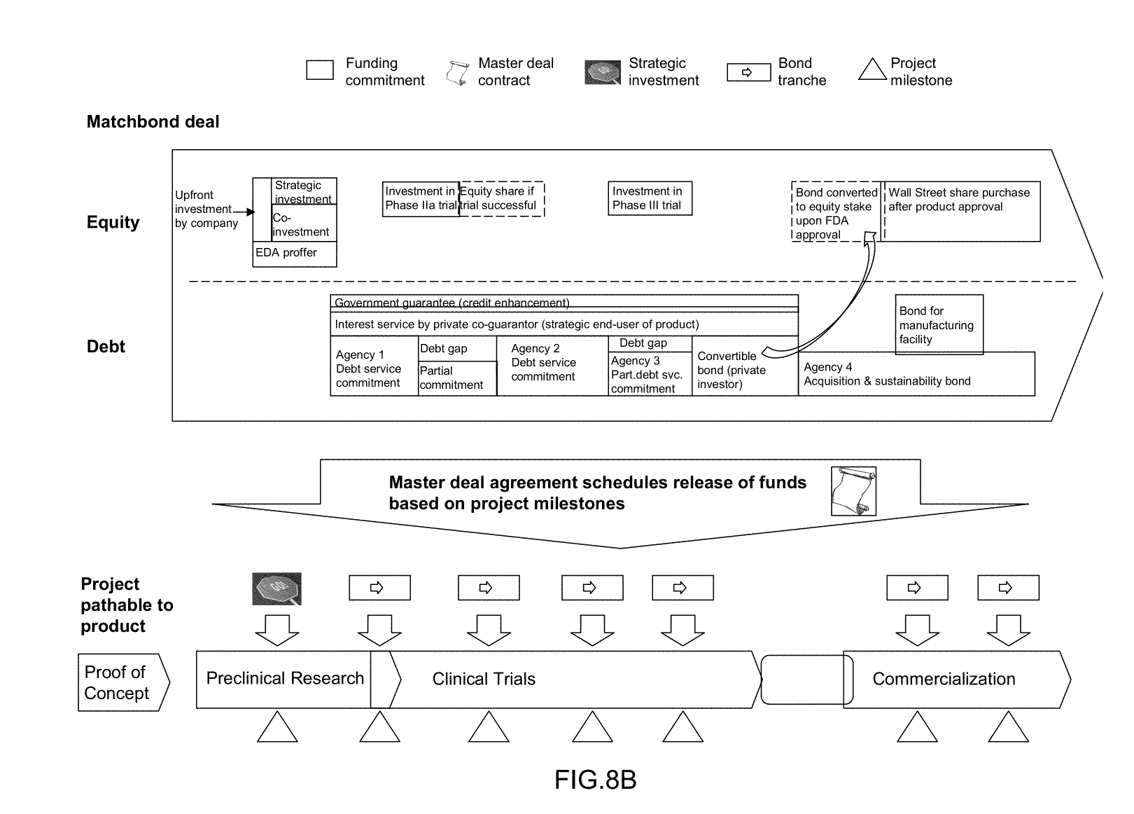

A deal engine 110 is configured to process inputs received from various sources via an input-output interface 105 and may facilitate and calculate matching to generate proposed deal terms, as will be discussed in further detail below. One example of an input-output interface 105 is shown in FIG. 1B as a graphical-user interface that may be configured to be displayed as part of an Internet browser interface, a computer-application interface, and/or a mobile device interface. Input-output interface 105 may be configured to communicate various data, including various inputs and outputs, to and from deal engine 110 of system 100. For example, users may input information, review potential matches and sub-matches, review other available data, and/or review deal terms via input-output interface 105. It is to be understood that the specific types of information depicted in FIG. 1B are merely exemplary and are not intended to limit the type of information that may be displayed as part of input-output interface 105, in which FIG. 1B shows an example/mockup of a computer interface, with panels/screens for each party/role with a deal assembly workspace and project and dealflow tracking panels. Each panel may, in some embodiments, comprise one or more individual screens available for viewing and interaction with all parties, or to only selected parties, or party types, or to only selected parties or party types after certain conditions or thresholds have been met. FIG. 8B shows a graphical representation of the project, the matchbond financing deal, and the master contract governing the deal. The project shown in FIG. 8B illustrates the scientific & implementation stages, as defined by the Research & Development Organization. The proposed matchbond deal, which is calculated by the deal engine, is a computerized representation of the laminated funding components which combine to achieve strategic continuity. The calculated laminated match deal or proposed deal is assembled by the system and then refined by the users, as represented in FIG. 8A, which is an example/mockup of a deal report generated by the system as the deal is being put together. When all the users confirm and commit, the draft master contract and all sub-contracts are generated by the system from standard contract templates stored in the system 100 and provided to the parties' legal representatives for review.

Referring again to FIG. 1A, a database 120 is configured to store data related to inputs received from each category of participants who may provide input data for system 100, as discussed above. It is to be understood that the database 120 may be configured as a single database, multiple distributed databases, or some combination thereof. The database may also include any combination of relational and non-relational databases configured to receive and facilitate access to information.

An analytics module 130 is configured to provide outputs related to information received by system 100. In some embodiments, analytics module 130 may facilitate basic access to information input to system 100 and stored in database 120 by users. For example, a product funding organization may input data related to a new initiative that may be accessible to all users of system 100, or only to selected users, or only to selected user categories, or only after one or more criteria are satisfied. In some embodiments, analytics module 130 may calculate and provide analytical information in response to one or more requests or queries to the system 100 for information stored by system 100. For example, analytics module 130 may receive a request regarding numbers and types of research and development organizations 20 that are operating in a certain geographic area. In addition, information may be requested regarding amounts and sources of funding received by these research and technology organizations over a specified time period. In embodiments, analytics module 130 may allow financial organizations to identify risks and benefits of specific deals, funding trends in industries, geographic areas, or specific companies, which may allow them to identify additional investment opportunities via system 100 or through other capital markets. In embodiments, analytics module 130 may generate a series of sub-matches of the various inputs using a given input as a starting point. For example, research and development organization 20 may input data into the system 100 to determine scenarios with various combinations of other players to achieve a fully funded product development plan for a pathable product.

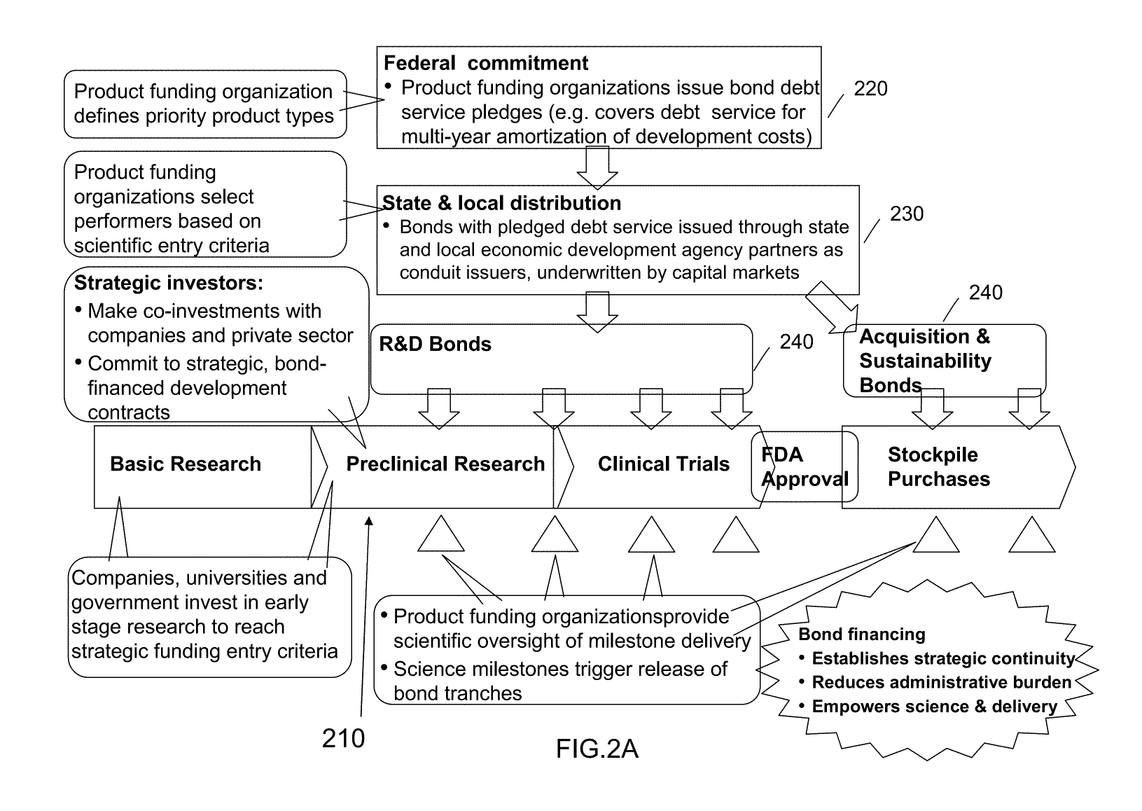

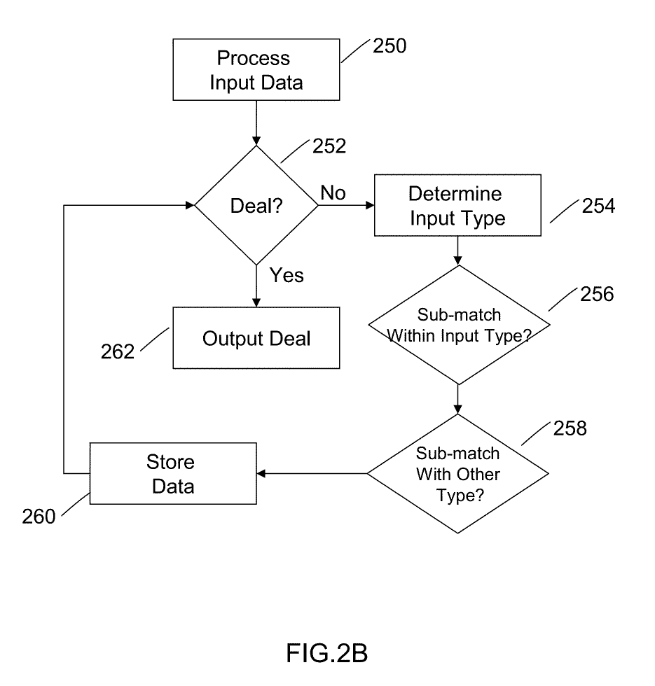

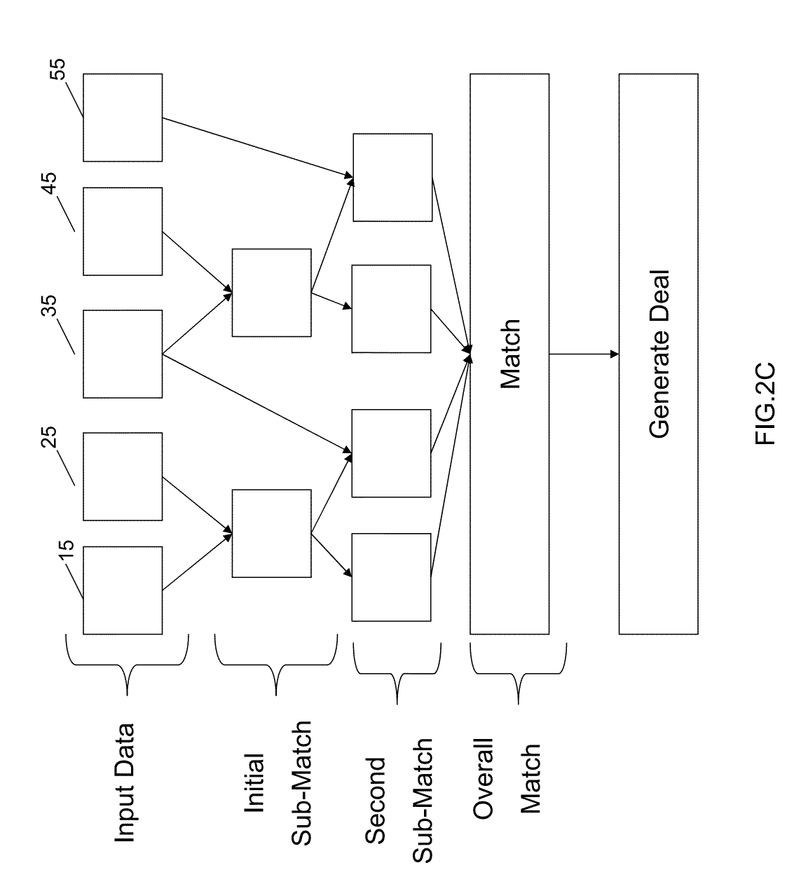

The system 100 of FIG. 1A will now be discussed in further detail with respect to FIGS. 2A-2C. As discussed previously, inputs received by system 100 may include some or all of research and development inputs, product funding organization inputs 15, economic development inputs 35, credit inputs 45, and bond purchaser inputs 55. Each category of inputs may include specific criteria or conditions related to the respective entity's goals, needs, and capabilities. For example, some research and development organizations 20 may provide research and development inputs 25 regarding a research and development opportunity for a product that requires additional funding before it can be commercialized. Likewise, product funding organizations 10 may examine public or private needs and determine what products or technologies could potentially meet those needs. Based on those needs, product funding organizations 10 provide pledges or guarantees.

Deal engine 110 facilitates the aligning and grouping of the various inputs to generate one or more sub-matches where in embodiments, a goal may be to obtain a complete funding for all stages of a product development path that may lead to a marketable product. In some embodiments, each input provided by an entity to system 100 and processed by deal engine 110 need not be a “complete” input that satisfies all necessary criteria to fund stages to generate a match for the generation of a marketable product. Each entity's input or inputs may be matched by the deal engine 110 to create one or more sub-matches that may be aligned to create a potentially fully or partially funded development path for a marketable product. For example, a first research and development organization 20 may be performing a research stage that may lead to a marketable vaccine product. A second research and development organization 20 may have the capabilities, resources, and availability to perform a pre-clinical research stage related to a vaccine product. A third research and development organization 20 may have the capabilities, resources, and availability to perform a clinical trial stage. These inputs received from the first, second, and third research and development organizations by system 100 and stored in database 120 may be processed by deal engine 110 to potentially generate a complete path to a marketable product. Alternatively, deal engine 110 may not have identified a complete development path based on these three organizations, it may have generated one or more strings of sub-matches that may be used subsequently, as more inputs are received, to develop a complete product development path. As will be explained in further detail below, such potential sub-matches may be identified by deal engine 110 with respect to the other types of inputs, as discussed above.

Deal engine 110 is operatively coupled to database 120 and is configured to access stored database information to determine whether one or more sub-matches regarding given input data are possible. As discussed previously, the nature of the sub-matches may vary based at least in part on the amount of relevant stored information available to deal engine 110. In some embodiments, the one or more computers may be configured with programming code to implement the deal engine 110 to evaluate input data to determine whether underlying criteria for a development stage have been satisfied and to determine what types of other inputs are needed to generate a complete funded or fundable path for a particular research and development project or technology. The remaining inputs or criteria that need to be satisfied may depend on the respective input that the deal engine 110 is currently evaluating. For example, if deal engine 110 is evaluating an input from a product funding organization 10 that specifies a product need, scientific criteria, proposed financing terms, and a level of guarantee, the remaining information may include facilitator inputs, research organization inputs, bond purchaser inputs, and credit inputs. Various sub-matching operations may be performed based at least in part on the data stored in the database 120 to determine if a complete fundable path for a particular research and development project can be achieved, and if not, what sub-matches are missing. Similarly, in another example, if deal engine 110 is evaluating an input 25 from a research organization 20 that includes a type of product being researched, scientific data related to the research and development, and a partial plan for the development of the product, the remaining information may be product funding organization inputs, facilitator inputs, bond purchaser inputs, credit inputs, and research organization inputs that may complete the development plan. Thus, the remaining pieces of data to obtain a complete funded or fundable path may vary depending upon which pieces of input data may be used as an initial basis of a query looking to create a complete funded or fundable path.

In one embodiment illustrated by FIG. 2A, deal engine 110 is configured to manage the process flow for a biotechnology product. In FIG. 2A, the research organization 20 is represented as “Life Science Companies,” that must satisfy the aforementioned criteria—having a pathable product, data supporting a proof of concept, and a plan—which may, in embodiments, entail one or more additional criteria to qualify for receiving the “Bond financing funds” as shown in FIG. 2A. In some embodiments, additional criteria may be used and may comprise the Life Science Companies having made an additional “upfront project investment” and having received “strategic investment funds” as mandatory pre-conditions for bond funding via system 100. These pre-conditions affirm that the research organization performing the research and development is committed to the project and has received adequate validation of its research and development.

In some embodiments, research and development validation may be based at least in part on such criteria requiring funding by strategic investors, as discussed previously. Although strategic investors provide inputs that include monetary investments with specific types of financing for certain products or technologies, they also serve a validation or certification function because they may have domain-specific knowledge that allows them to identify research and development or technologies that are based on sound scientific practices. As such, they or others may provide certification information as an additional input to the system 100 related to their vetting capabilities that may be associated with research and development or technologies that the strategic investor has evaluated or in which the strategic investor has invested.

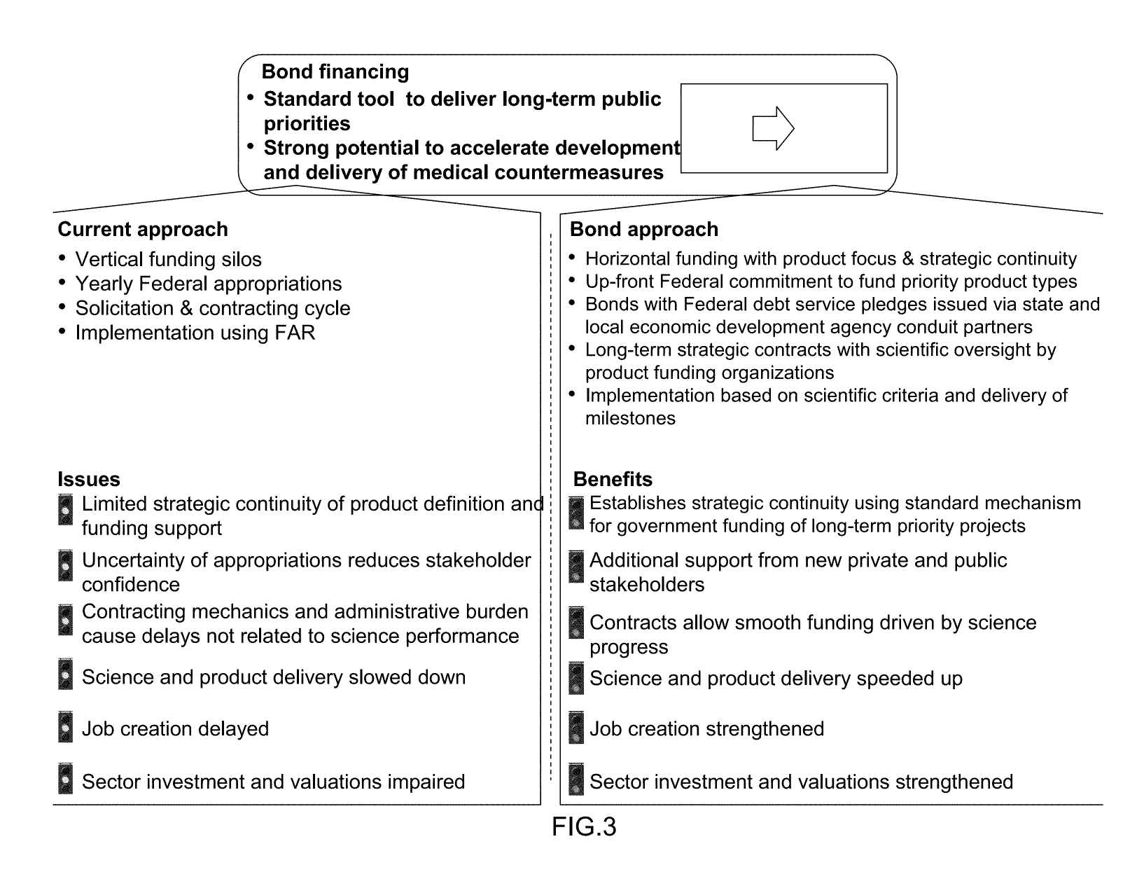

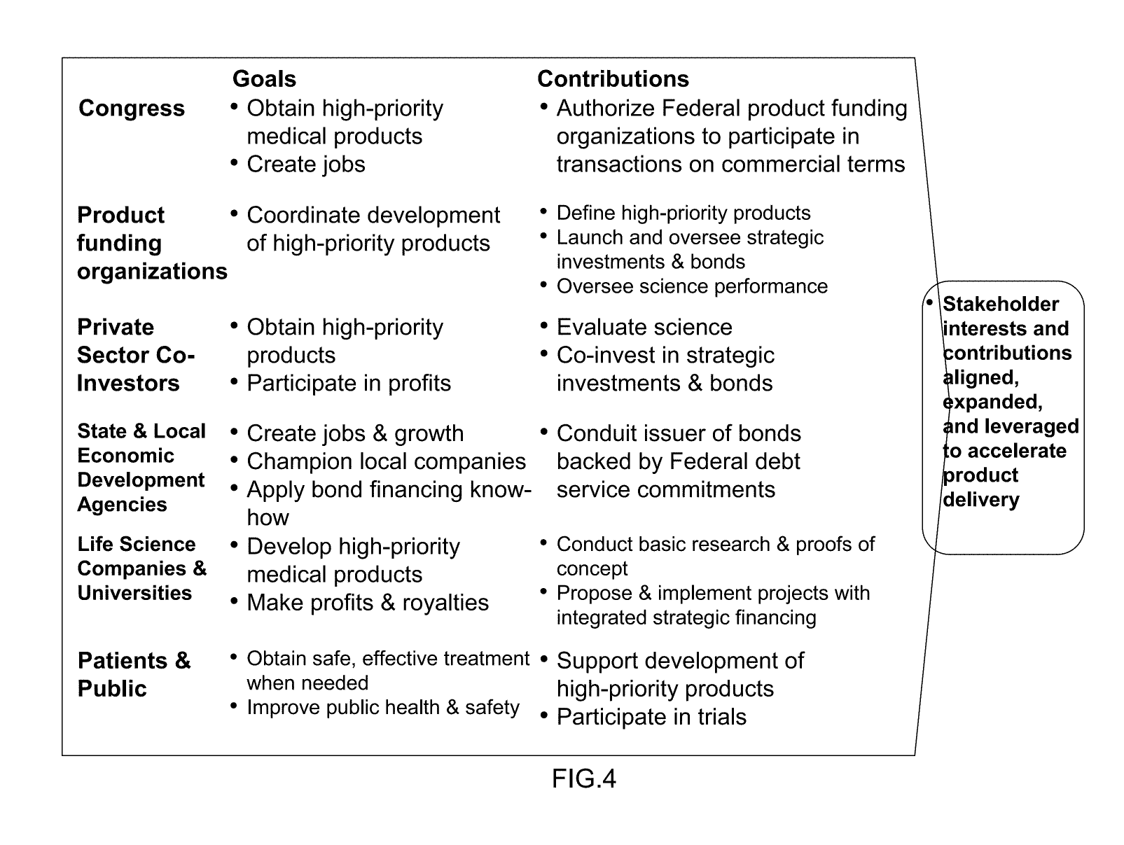

As shown in FIG. 2A, in one embodiment, a product development path 210 may be divided by stages with milestones associated with development progress. Individual research organizations 20 may contribute to one or more stages of the product development path for a particular research and development opportunity based on their skills, resources, and capabilities that were identified based at least in part on their research and development or technology development inputs supplied to system 100. In some embodiments, research organizations may also contribute to multiple stages of a product development path 210 to generate a complete path to a marketable product. By creating a complete product development path 210, research and development projects are no longer subject to the drawbacks of the current approach, such as vertical funding silos and multiple funding applications, as shown in the left column of FIG. 3. Furthermore, this approach aligns the goals and interests of the participants in the process based on their contributions, as shown in FIG. 4. In the example shown in FIG. 2A using a Federal Commitment 220 and a State and Local Distribution 230 for Bonds 240, the entire product development path 210 may be funded.

As shown in FIG. 2B, one or more embodiments of deal engine 110 according to the present invention provide for input processing and matching.

Block 250 comprises an operation of obtaining input data. As discussed previously, in embodiments, the input data may include research and development and technology inputs 25, product funding organization inputs 15, economic development inputs 35, credit inputs 45, and/or bond purchaser inputs 55. In some embodiments, a query may also be received or generated, with one or more of the inputs as base inputs. As discussed, the manner of obtaining the inputs is not limiting on the invention, and may include receiving the input data over a network, and generating some of the input data, or may be in response to Pull queries, and/or some of the data may be received by mail, fax, telephone, and then keyed and/or scanned into the system.

Block 252 comprises determining, using the one or more computers, whether a deal related to any of the received inputs or data previously stored in database 120 of system 100 allows a deal to be generated to fund some, none, or all of the development path to a marketable product. This operation, in some embodiments, may comprise generating one or more initial sub-matches with one or more base inputs. The operation may be followed with one or more secondary and tertiary sub-matches, based at least in part on these initial sub-matches. This sequential sub-matching operation is illustrated in FIG. 2C. For example, a query may be received from an organization 20 including input data 25 on a pathable product. An initial sub-match may be performed by the one or more computers, to obtain a sub-match with an example product funding organization inputs 15 (e.g., government data indicating a bond guarantee for a given product), or with economic development inputs 35 (e.g., an economic development agency in the same county as the company that might be interested in issuing bonds to fund one or more stages of the product development). A second sub-match may comprise matching possible companies with all of the stages in a product development path. If an initial sub-match was obtained for this R&D organization input data 25, then the one or more computers would search for secondary sub-matches with credit inputs 45 and/or bond purchaser inputs 55. There may then be a search for additional sub-matches before an Overall Match is generated. The illustrated example depicting two sub-matches is merely exemplary of the matching process contemplated. It should be understood that numerous additional sub-matches may be performed (e.g. 5, 10, 20, etc.) before arriving at an Overall Match. Note that in other embodiments, sub-matching may be performed where a processing operation may be used to obtain multiple sub-matches in parallel to determine whether a deal may be achieved by determining intra-category sub-matches and overall sub-matches before generating a deal.

If a deal is possible, e.g., a complete or substantially complete funding of pathable research and development leading to a marketable product, then the process continues to Block 262. In some embodiments, block 262 may comprise one or more of the steps of publishing the various aspect of the deal, either by display or email or other means, and/or generating a term sheet for the deal, to be discussed.

If no deal is possible, the process proceeds to Block 254. In some embodiments, block 254 comprises determining, using the one or more computers, the data and/or sub-matches that are missing and thus prevent a fully or substantially complete path being funded. Further, block 254 may comprise the steps of identifying the type of input data that was received by determining whether the input data is one of a product funding organization input 15, a research and development and/or technology input 25, an economic development input 35, a credit input 45, or a bond purchaser input 55.

Block 256 comprises determining whether a sub-match may be generated within the input type associated with at least one of the received input data. For example, a received research and development and/or technology input 25 may relate to a single stage of a research and development plan. Such received research and development and/or technology input may be sub-matched with existing research and development and/or technology inputs previously stored in database 120 of system 100 to generate a larger sub-match for several stages of the development path.

Block 258 comprises determining whether a sub-match may be generated with data having a different type than at least one of the received input data. For example, a received research and development and/or technology input 25 may be sub-matched with an existing economic development input 35 previously stored in database 120 of system 100 to generate a larger sub-match based on the received research and development and/or technology input 25.

Block 260 comprises storing the received input data in database 120.

Block 262 comprises outputting terms associated with a deal generated by deal engine 110 based on stored and input data.

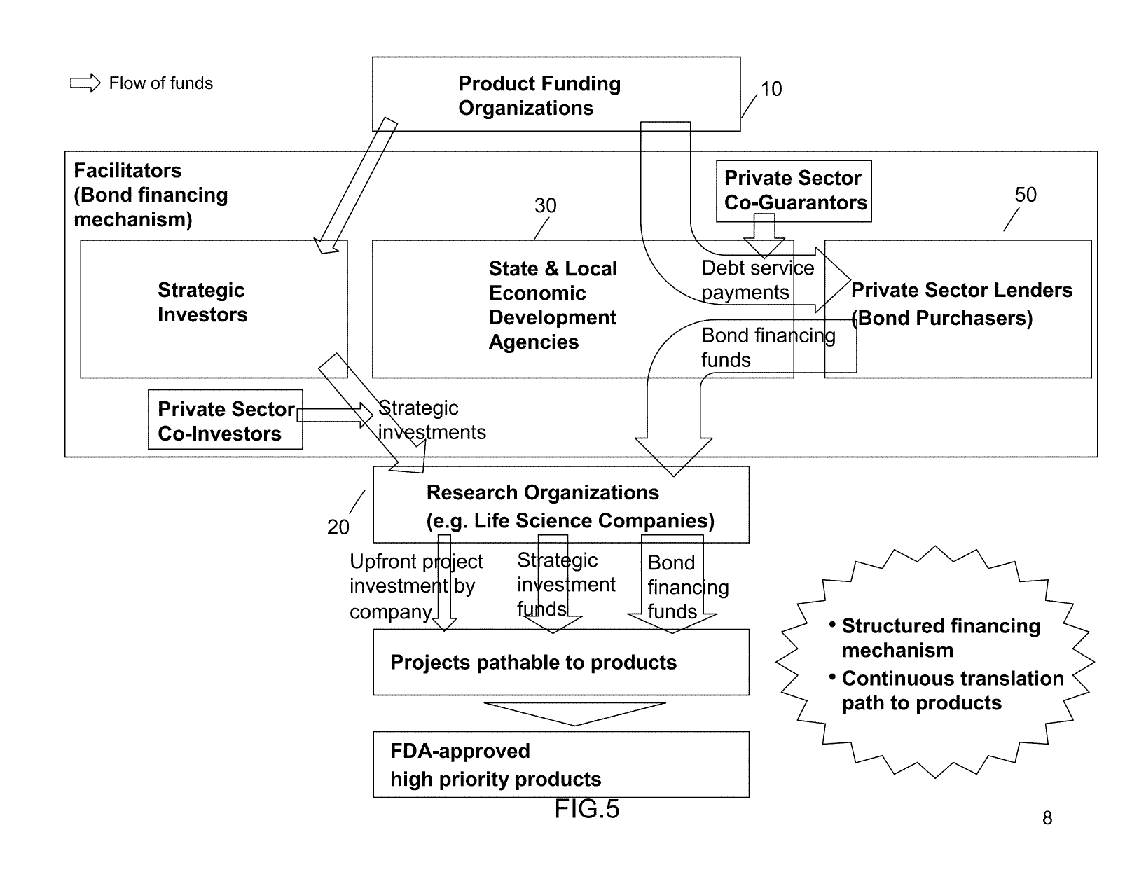

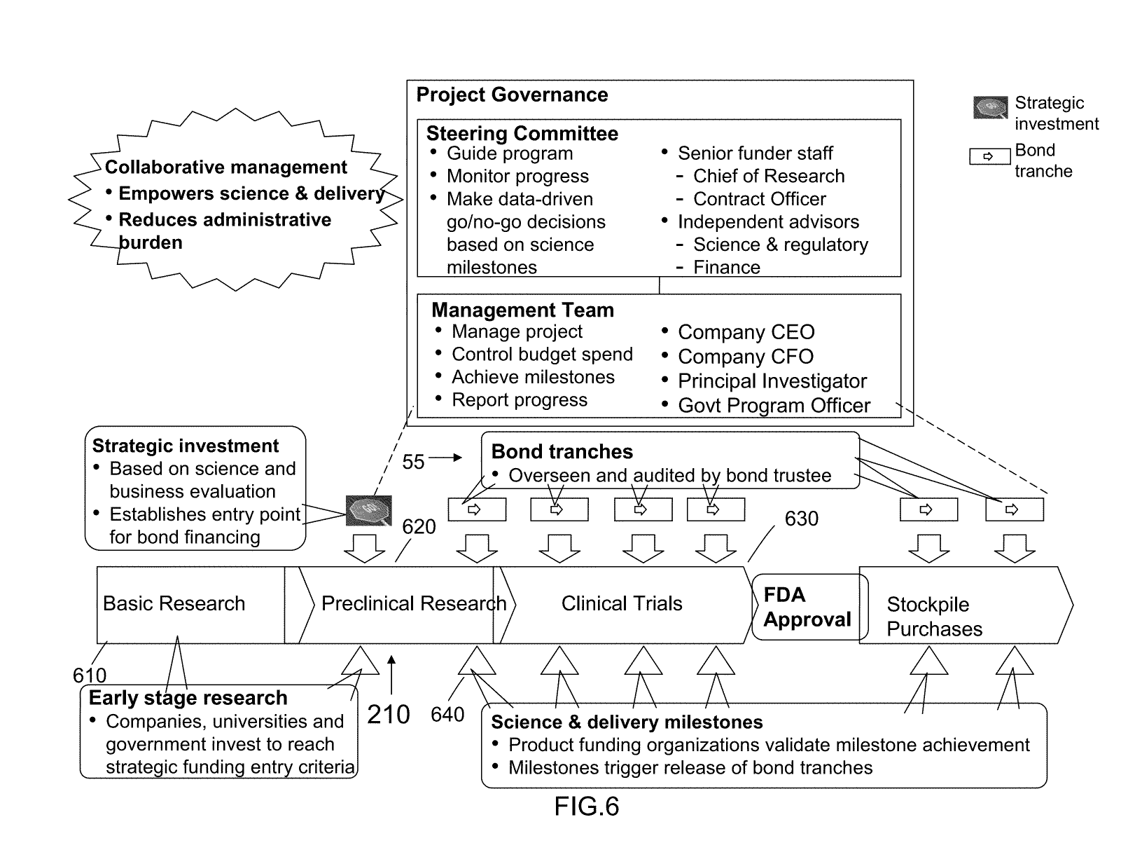

FIG. 5 illustrates embodiments where the economic developers 30 are generally represented as “State & Local Economic Development Agencies” (EDAs). EDAs generally have bond authority based on guarantees received from a product funding organization 10, such as the “Federal Agencies” shown in FIG. 5. EDAs 30 are able to issue bonds based on such guarantees to fund research and development opportunities from research and technology organizations 20, such as “Life Science Companies,” that meet their respective input criteria. As shown in FIG. 5, Debt service payments and Bond financing funds can both flow through the EDA as the conduit issuing authority for purchased bonds. In one example, a bond debt service pledge or other assignable funding guarantee provided by a federal agency 10 may serve as the funding basis or guarantee for a bond issued by a local EDA to fund research and development being conducted within the jurisdiction of the EDA. The EDA 30 has input such details to system 100, and those details may be retrieved by deal engine 110 to facilitate a funding match. More specifically, deal engine 110 may identify the EDA input 15 as a potential sub-match for a research organization that is located within the jurisdiction or could commit to perform further research and development within the jurisdiction. As shown in further detail in FIG. 6, individual bond tranches purchased by bond purchasers 50 may be assigned or allocated to individual stages 610, 620, 630 or milestones 640 of the product development path 210.

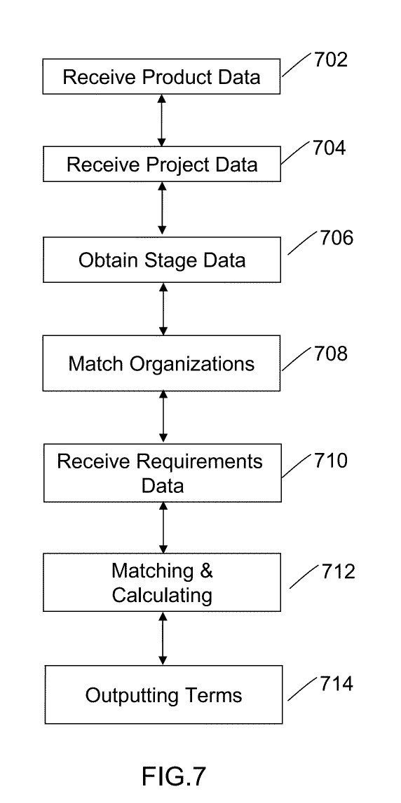

As shown in FIG. 7, embodiments of a method for implementing the present invention are provided. Block 702 comprises obtaining research product development inputs 25, and storing the data, using the one or more computers, in the database 120.

Block 704 comprises obtaining product funding organization data identifying an innovative technology product to be developed, and in some embodiments, at least two product funding organization criteria to be met, wherein the at least two product funding organization criteria may, in embodiments, include at least an amount of a bond payment pledge or guarantee for debt service of bonds, the proceeds designated to fund at least one stage of a complete product development path that comprises a plurality of stages for product development of the innovative technology product.

Block 706 comprises obtaining data on the plurality of stages for the product development, with each of the stages comprising one or more stage requirements.

Block 708 comprises matching or receiving data for a match, using the one or more computers, of one or more organizations that can perform work to meet the stage requirements of one or more of the respective stages of the respective product development.

Block 710 comprises an operation of obtaining requirements data of respective bond issuers for issuing respective bonds for funding one or more of the stages of the complete development path, where the bonds are to receive the product funding organization pledge or bond payment guarantee for partial or complete debt service.

Block 712 comprises an operation of matching, using the one or more computers, one of the stages with the requirements data for one of the bond issuers, and generating data for an allocation of at least part of the amount of the product funding organization bond payment pledge or guarantee to the at least one of the stages.

In some embodiments, the matching and allocating operation may also comprise calculating financial terms related to potential deals. For example, financial terms may comprise interest rates, payment schedules, credit enhancement, insurance, pledges of assets, or other information that would be understood to one of ordinary skill in the art as impacting financial deal terms.

The deal engine 110 may make matching and financial calculations of block 712, including, but not limited to the following:
Financial calculations for individual deals, include but are not limited to, calculating of the total funding needed for the deal or sub-deal; if equity, equity terms and conditions; if debt, debt terms and conditions, such as interest rates, repayment schedule, collateral and/or surety requirements, and any other related debt terms; cash flow and net present value for each party;
Calculations of deals based on portfolios of pathable projects, including but not limited to, total funding needs and equity and debt terms for portfolios made up of multiple pathable projects directed at a single product or at multiple products, such as multiple scientific projects aimed at the same product goal using different scientific approaches (e.g. a vaccine and a drug and an antibody treatment) including licensing, cross-licensing, and cross-royalties terms to allow optimization of net present value and other benefits for all parties, even in the case of science failure of one or more components of the portfolio;
Risk and benefit calculations, including but not limited to net present value, time value of money, Monte Carlo simulation, and other calculations allowing quantification of deals;
Creation of positive funding and investment feedback loops using financial pools from profits of commercialized products to seed new projects. For example, increasing the net present value of a deal for a product funding organization by including royalty and other revenue participation terms in deals in case of product licensure and commercial success;
Calculation of the use of warrants, contingent value rights and other debt and equity instruments to optimize stakeholder value;
Achieve fully linked financing pathways by aligning and matching deal criteria between multiple product funding organizations and facilitators to bridge existing funding conditions, boundaries, and gaps to achieve continuous strategic funding needed to advance products to licensure and commercialization.

In some embodiments, block 714 comprises outputting deal terms and requirements. In embodiments, multiple deal terms may be output where multiple potential matches were generated, which then allows for the most favorable set of terms to be selected. In embodiments, the outputted deal terms or proposed or prospective deal terms may include a deal report, as shown in FIG. 8A. This is an example/mockup of a computer interface of a deal report generated by the system representing a deal as it is being put together. Deal term inputs may be designated, in embodiments, as firm or proposed, where a proposed input may be contingent on one or more conditions being met. FIG. 8B shows a graphical representation of the project, the matchbond financing deal, and the master contract governing the deal. In some embodiments, the master contract may be generated by the system from stored standard contract terms and templates and may include sub-agreements generated according to standards and meta-standards established by the system 100. The project shows the scientific & implementation stages, as defined by the Research & Development Organization. The proposed (calculated) matchbond deal is a graphical representation of the laminated funding components which combine to achieve strategic continuity. The calculated laminated matched deal or proposed deal is assembled by the system and then refined by the users. When all the users confirm and commit, the draft master contract and all sub-contracts are generated by the system and provided to the parties' legal representatives for review.

It should be understood that the equity and debt investments illustrated in FIG. 8B may be coupled to or decoupled from individual stages or milestones illustrated based at least in part on negotiated and investment terms included in the deal terms.

Embodiments may determine, using the one or more computers, based at least in part on the respective requirements data of respective bond issuers 30 for issuing respective bonds, at least one match of a respective one of the bond issuers and a stage of the complete development path and a research organization 20 that meets in whole or in part the requirements data of the one respective bond issuer 30. In some embodiments, bonds may relate to research and development bonds, acquisition and sustainability bonds, or some combination thereof aligned to provide continuous funding of a pathable product.

As noted previously, data obtaining steps may comprise receiving the data electronically via one or more network connections and/or may comprise receiving the data by mail, and/or by facsimile, and/or by telephone, and/or orally, and keying and/or scanning the data into the system 100, or may comprise pulling the data from a database or other entity, or may comprise generating some of the data.

In some embodiments, to achieve computerized generation of deals, additional computerized elements and functions may comprise:
Definition of parties and roles; definition of process algorithms for developing deals; elaboration of integrated workflows, integrated logic schemes and calculation of funding flows; definition of functional modules, data structures, interfaces, analytics, and outputs;
Definition of a Deal Engine, including financial calculations for individual deals and types of deals; calculations of deals based on portfolios of pathable projects; risk and benefit calculations; creation of positive funding and investment feedback loops using financial pools from profits of commercialized products to seed new projects; calculation of the use of warrants, contingent value rights and other debt and equity instruments to optimize stakeholder value and achieve fully linked financing pathways
Definition of interfaces and software tools;
Definition of criteria for achievement of scientific proof of concept, and definition of scientific pathways to products;
Definition of lists of high-priority products (“white books”) stating the product and funding goals and commitments of product funding organizations
Definition of projects pathable to products
Definition and implementation of standardized legal forms for deals, including master agreements and subagreements covering individual deal elements
Definition of deal term sheets
Creation of financial pools and review board for elective prioritization of products based on science proof of concept independent of funding organization priorities
Networked contact management and communication environments for system participants
And the constructs, standards, and protocols needed to embody any and all of the elements described in the system.

Some embodiments may provide that received funding requirements data comprise at least two of a geographic requirement, a technology requirement, or an economic requirement. For example, received funding requirements data may comprise an identified state or local jurisdiction, biotechnology work, and a requirement to create 100 jobs, respectively.

Some embodiments may provide that obtaining information on a complete development path for the innovative technology product to be developed comprises receiving at least a partial path proposal and a proof of concept. Some embodiments may provide for generating a term sheet based at least in part on a complete development path and an allocation of at least part of an amount of the product funding organization bond payment pledge or guarantee.

Some embodiments may provide for matching or receiving data for a match, using the one or more computers, for at least one purchase commitment to at least one tranche of bonds to be issued by the one bond issuer for the stage of the development. Some embodiments may provide that matching of the purchase commitment occur contemporaneously with the matching of the one of the stages with the requirements data for one of the bond issuers.

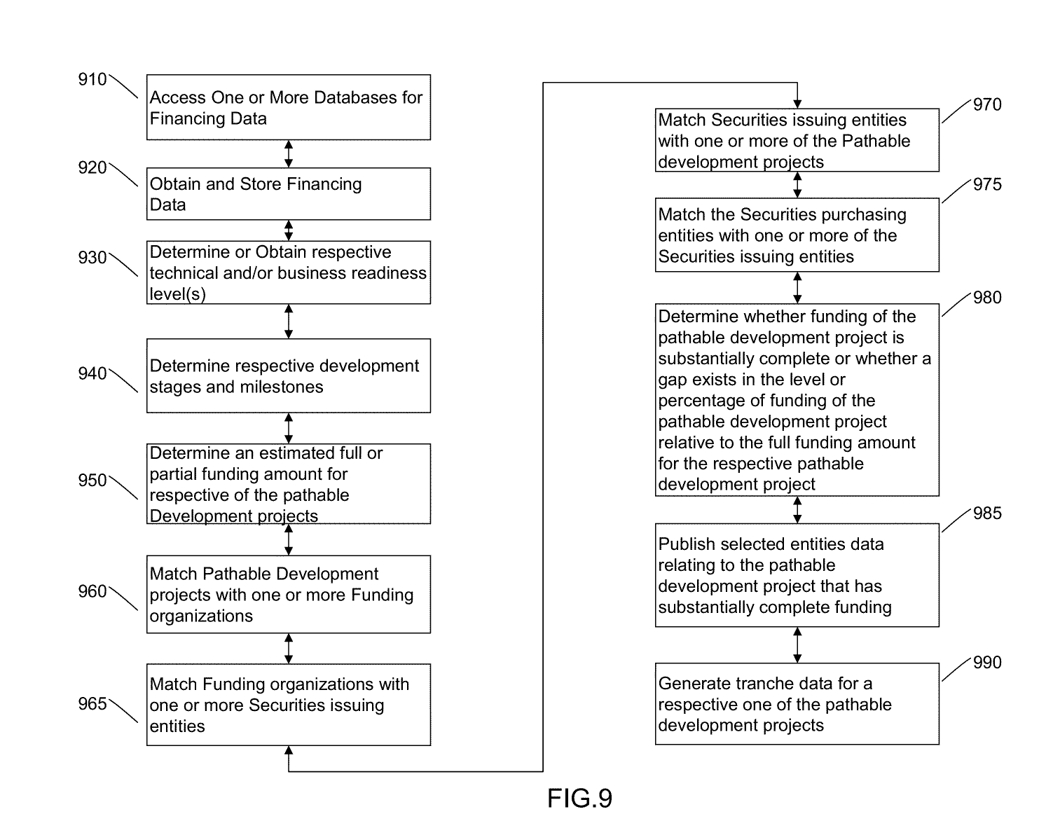

A finance method according to an embodiment is described below, with reference to FIG. 9. In stage 910, one or more databases on computer-readable storage media are accessed by one or more computers, in which those databases store information regarding: a) research and development organizations, b) product development projects associated with respective of the research and development organizations, c) funding organizations, and respective organization funding requirements including a technical and/or business readiness requirement for the respective product development projects, d) securities issuing entities, and respective issuing entity requirements, e) securities purchasing entities with one or more securities purchase criteria, and b) pathable development projects. A pathable project corresponds to a project with a timeline or path that includes a plurality of development stages and milestones related to the development of a marketable product from one of the product development projects.

In embodiments, in stage 920, the one or more computers obtain and store over time, data for: a) product development projects, b) research and development organizations, c) funding organizations, and respective organization requirements, d) securities issuing entities, and respective issuing entity requirements, e) securities purchasing entities, and f) pathable development projects.

In embodiments, in stage 930, a respective technical and/or business readiness level may be determined or obtained for each of a plurality of the product development projects, and the respective readiness levels are stored in the one or more databases. See Table 1 below for a list of representative technology readiness levels and Table 2 below for a list of representative business readiness levels.

In embodiments, in stage 940, for each of a plurality of the product development projects, respective development stages and milestones may be determined by the one or more computers for a respective pathable development project and one or more entities to perform the respective development stages.

In embodiments, in stage 950, an estimated full or partial funding amount for respective of the pathable development project may be determined by the one or more computers.

In embodiments, in stage 960, a matching may be performed, using the one or more computers, of a respective one of the pathable development projects with one or more of the funding organizations, based at least in part on matching the organization requirements of the respective funding organization to at least one selected from the group of: a) the technical and/or business readiness level of the product development project associated with the respective pathable development project, b) a target product profile, c) an amount of available funds for a given target product profile, an d) approximate timeframe for completion of the pathable development project, and e) a requested co-funding amount.

In embodiments, in stage 965, a matching may be performed, using the one or more computers, of one or more of the funding organizations with one or more of the securities issuing entities, based at least in part on the respective issuing entity requirements of the respective issuing entities relating to at least one selected from the group of: a) jobs projected to be created by the respective pathable development project, b) location of work for the respective pathable development project, and c) technology type.

In embodiments, in stage 970, a matching may be performed, using the one or more computers, of one or more of the securities issuing entities with one or more of the pathable development projects, based at least in part on at least one selected from the group of: a) a projected financial return, b) a schedule of tranches for the stages of the pathable development project, and c) a surety arrangement.

In embodiments, in stage 975, a matching may be performed, using the one or more computers, of one or more of the securities purchasing entities with one or more of the securities issuing entities, based at least in part on at least one selected from the group of: a) level or percentage of funding relative to the funding amount for the respective pathable development project, b) a projected financial return, c) a schedule of tranches for the stages of the pathable development project, and d) a surety arrangement.

In embodiments, in stage 980, a determining may be performed, using the one or more computers, of whether funding of the pathable development project is substantially complete relative to the full funding amount for the respective pathable development project or determining a gap in the level or percentage of funding of the pathable development project relative to the full funding amount for the respective pathable development project.

In embodiments, in stage 985, selected entities' data relating to the pathable development project that has substantially complete funding and/or comprise results of individual matching steps may be published to at least one selected entity.

In embodiments, in stage 990, tranche data may be generated and selected, using the one or more computers, for a respective one of the pathable development projects, to one or more entities that are to perform the development stages for the respective pathable development project.

### Deal Engine

The deal engine 110 is configured to process data and inputs received from various sources and to calculate matching to generate proposed deal terms, as will be discussed in further detail below.

### Deal Engine: Technology and Business Readiness Levels

According to one or more embodiments, deal engine 110 may use data regarding Technology Readiness Levels (TRLs) and Business Readiness Levels (BRLs) to match product funding organizations and investors with research and development companies through all stages of product development.

Table 1 lists TRLs that may be used for biotechnology products (similar ratings may be used for other technical fields, such as space systems, weapons development, etc.), according to one or more embodiments. In particular, nine (9) separate TRLs are illustrated in Table 1, which are used by the deal engine 110 to match investors with research and development companies through all stages of product development. The TRLs may correspond to various portions of the scientific & implementation stages shown in FIG. 8B.

Table 2 lists BRLs that may be used for biotechnology products, in which similar ratings can be used for other technical fields. In particular, nine (9) separate BRLs are listed in Table 2, which can be used by the deal engine 110 to match investors with research and development companies through all stages of product development. The BRLs may correspond to various organizational capacities and capabilities which may be needed and/or advisable to have in order to perform the corresponding scientific & implementation stages shown in FIG. 8B.

In some embodiments, product funding organization inputs 15 provided by product funding organizations are matched to the various nine TRL stages (see FIG. 1A and Table 1), and the various nine Business Readiness Levels (BRLs) (see Table 2), to provide funding from product conception up to final product testing and subsequent manufacturing.

TABLE 1
TRL Integrated Medical Countermeasure TRLs (based on October 2004 DoD Medical
TRLs and May 2008 PHEMCE TRLs)

| | |
|---|---|
| 1 | Review of Scientific Knowledge Base |
| | Active monitoring of scientific knowledge base. Findings are reviewed and assessed as a |
| | foundation for characterizing new technologies. |
| 2 | Development of Hypotheses and Experimental Designs |
| | Scientific paper studies to generate research ideas, hypotheses, and experimental designs for |
| | addressing the related scientific issues. Focus on practical applications based on basic principles |
| | observed. Use of computer simulations or other virtual platforms to test hypotheses. |
| 3 | Target/Candidate Identification and Characterization of Preliminary Candidate(s) |
| | Begin research, data collection, and analysis in order to test hypothesis. Explore alternative |
| | concepts, identify and evaluate critical technologies and components, and begin characterization |
| | of candidate(s). Preliminary efficacy demonstrated in vivo. |
| 3A | Identify target and/or candidate |
| 3B | Demonstrate in vitro activity of candidate(s) to counteract the effects of the threat agent. |
| 3C | Generate preliminary in vivo proof-of-concept efficacy data (non-GLP) |
| 4 | Candidate Optimization and non-GLP In Vivo Demonstration of Activity and Efficacy |
| | Integration of critical technologies for candidate development. Initiation of animal model |
| | development. Non-GLP in vivo toxicity and efficacy demonstration in accordance with the |
| | product's intended use. Initiation of experiments to identify markers, correlates of protection, |
| | assays, and endpoints for further non-clinical and clinical studies. |
| | Animal Models: Initiate development of appropriate and relevant animal model(s) for the desired |
| | indications. |
| | Assays: Initiate development of appropriate and relevant assays and associated reagents for the |
| | desired indications. |
| | Manufacturing: Manufacture laboratory-scale (i.e. non-GMP) quantities of bulk product and |
| | proposed formulated product. |
| 4A | Demonstrate non-GLP in vivo activity and potential for efficacy consistent with the product's |
| | intended use (i.e. dose, schedule, duration, route of administration, and route of threat agent |
| | challenge). |
| 4B | Conduct initial non-GLP toxicity studies and determine pharmacodynamics and pharmacokinetics |
| | and/or immune response in appropriate animal models (as applicable). |
| 4C | Initiate experiments to determine assays, parameters, surrogate markers, correlates of protection, |
| | and endpoints to be use during clinical and non-clinical studies to further evaluate and |
| | characterize candidate(s). |
| 5 | Advanced Characterization of Candidate and Initiation of GMP Process Development |
| | Continue non-GLP in vivo studies, and animal model and assay development. Establish draft |
| | Target Product Profiles. Develop a scalable and reproducible manufacturing process amenable to |
| | GMP. |
| | Animal Models: Continue development of animal models for efficacy and dose ranging studies. |
| | Assays: Initiate development of in-process assays and analytical methods for product |
| | characterization and release, including assessments of potency, purity, identity, strength, sterility, |
| | and quality as appropriate |
| | Manufacturing: Initiate process development for small-scale manufacturing amenable to GMP |
| | Target Product Profile: Draft preliminary Target Product Profile. Questions of shelf life, storage |
| | conditions, and packaging should be considered to ensure that anticipated use of the product is |
| | consistent with the intended use for which approval will be sought from the FDA. |
| 5A | Demonstrate acceptable Absorption, Distribution, Metabolism, and Elimination characteristics |
| | and/or immune responses in non-GLP animal studies as necessary for IND filing. |
| 5B | Continue establishing correlates of protection and/or surrogate markers for efficacy for use in |
| | future GLP studies in animal models. Identify minimally effective dose to facilitate determination of |
| | “humanized” dose once clinical data are obtained. |
| 6 | GMP Pilot Lot Production, IND Submission, and Phase 1Clinical Trials |
| | Manufacture GMP pilot lots. Prepare and submit Investigative New Drug (IND) package to the |
| | FDA and conduct Phase 1 Clinical Trial(s) to determine the safety and pharmacokinetics of the |
| | clinical test article. |
| | Animal models: Continue animal model development via toxicology, pharmacology, and |
| | immunogenicity studies. |
| | Assays: Qualify assays for manufacturing quality control and immunogenicity, if applicable. |
| | Manufacturing: manufacture, release, and conduct stability testing of GMP bulk and formulated |
| | product in support of IND and Clinical Trial(s). |
| | Target Product Profile: Update the Target Poduct Profile as appropriate. |
| 6A | Conduct GLP animal studies for toxicology, pharmacology, and immunogenicity as appropriate. |
| 6B | Prepare and submit a full IND package to FDA to support Clinical Trial(s). |
| 6C | Compete Phase 1 Clinical trial(s) that establish an initial safety and pharmacokinetics |
| | assessment. |
| 7 | Scale-up, Initiation of GMP Process Validation, and Phase 2 Clinical Trial(s)3 |
| | Scale-up and initiate validation of GMP manufacturing process. Conduct animal efficacy studies |
| | as appropriate. Conduct Phase 2 Clinical Trial(s). |
| | Animal Models: Refine animal model development in preparation for pivotal GLP animal efficacy |
| | studies. |
| | Assays: Validate assays for manufacturing quality control and immunogenicity if applicable. |
| | Manufacturing: Scale-up and validate GMP manufacturing process at a scale compatible with |
| | USG requirements. Begin stability studies of the GMP product in a formulation, dosage form, and |
| | container consistent with Target Product Profile. Initiate manufacturing process validation and |
| | consistency lot production. |
| | Target Product Profile: Update Target Product Profile as appropriate. |
| 7A | Conduct GLP animal efficacy studies as appropriate for the product at this stage4. |
| 7B | Complete expanded clinical safety studies as appropriate for the product (e.g., Phase 2). |
| 8 | Completion of GMP Validation and Consistency Lot Manufacturing, Pivotal Animal Efficacy |
| | Studies or Clinical Trials3, and FDA Approval or Licensure. |
| | Finalize GMP manufacturing process. Complete pivotal animal efficacy studies or Clinical Trials |
| | (e.g., Phase 3), and or expanded clinical safety trials as appropriate. Prepare and submit |
| | NDA/BLA. |
| | Manufacturing: Complete validation and manufacturing of consistency lots at a scale compatible |
| | with USG requirements. Complete stability studies in support of label expiry dating. |
| | Target Product Profile: Finalize Target Product Profile in preparation for FDA approval. |
| 8A | Complete final pivotal GLP animal efficacy studies or pivotal Clinical Trials (e.g., Phase 3), and |
| | any additional expanded clinical safety trials as appropriate for the product. |
| 8B | Prepare and submit New Drug Application (NDA) or Biologics Licensing Application (BLA) to the |
| | FDA. |
| 8C | Obtain FDA approval or licensure. |
| 9 | Post-Licensure and Post-Approval Activities |
| 9A | Commence post-licensure/post-approval and Phase 4 study commitments, such as safety |
| | surveillance, data to support use in special populations, and Clinical Trials to confirm safety and |
| | efficacy as feasible and appropriate.5 |
| 9B | Maintain manufacturing capability as appropriate. |

TABLE 2
Business Readiness Levels (BRLs)

| BRL | Description | Details (Indicative; Non-exhaustive) |
|---|---|---|
| 1 | Startup entity. Business entity | Legal aspects: Company incorporated; IP protected and secured to |
| | founded, technology | company |
| | transferred in, and ready to | Operational Capacity: Company resources are minimal, I.e. |
| | commence initial technology | facilities, cash, staff, equipment near zero |
| | studies (e.g. for a | Technical Capacity: Key collaborators identified but not yet |
| | biotechnology application, | contracted |
| | initial preclinical studies) | Financial Capacity: Backing by founders and angels; no strategic |
| | | backer; no VC |
| 2 | Basic business capability to | Operational Capacity: Initial facilities, staff and equipment |
| | move forward with | available |
| | Translational R&D | Technical Capacity: Key collaborators contracted, initial studies |
| | | underway |
| | | Financial Capacity: Series A or equivalent funding complete. |
| 3 | Capacity to demonstrate initial | Operational capacity: Sufficient business staff, facilities and |
| | performance of the technology | equipment to support business operations at this level. |
| | (e.g. for a biotechnology | Technical Capacity: Sufficient full-time staff to reliably oversee |
| | application, in vitro activity) | translational research program. Key in-house R&D capacities |
| | | beginning to develop. Demonstrated capability to manage external |
| | | collaborators. |
| | | Financial Capacity: Sufficient cash on hand and/or investment |
| | | commitments to enable continuous operations. |
| 4 | Capacity to support proof-of- | Operational Capacity: Sufficient business and operational staff, |
| | concept studies (e.g. for a | facilities and resources to support business operations at proof-of- |
| | biotechnology application, | concept level. |
| | proof of therapeutic protection | Technical Capacity: Sufficient R&D staff and resources to oversee |
| | (for a drug), well- | translational research program at this level. In-house capabilities |
| | characterized immune | such as manufacturing, quality assurance, regulatory, and product- |
| | response (for a vaccine), etc.) | specific technical functions beginning to develop. |
| | | Financial Capacity: Sufficient cash on hand and/or investment |
| | | commitments to enable continuous operations. |
| 5 | Capacity to initiate prototype | Operational Capacity: Sufficient business and operational staff, |
| | manufacturing and testing | facilities and resources to support business operations at this level. |
| | (e.g. for a biotechnology | Project/program management capability beginning to develop. |
| | application, GMP | Technical Capacity: Sufficient R&D staff and resources to conduct |
| | manufacturing and GLP safety | and oversee translational research program at this level. |
| | testing) | Financial Capacity: Sufficient cash on hand and/or investment |
| | | commitments to enable continuous operations. |
| 6 | Capacity to support quality- | Operational Capacity: Sufficient business and operational staff, |
| | assured manufacturing and | facilities and resources to support business operations at this level. |
| | initial regulatory interactions | Project/program management capability implemented and growing. |
| | (e.g. for a biotechnology | Technical Capacity: Sufficient R&D staff and resources to conduct |
| | application, GMP | and oversee translational research program at this level. Substantial |
| | manufacturing, IND and Phase | capability in quality-assured manufacturing of prototype product, |
| | 1 clinical trials) | capability to oversee validated testing of prototype product. |
| | | Financial Capacity: Sufficient cash on hand and/or investment |
| | | commitments to enable continuous operations. |
| 7 | Capacity to support advanced | Operational Capacity: Sufficient business and operational staff, |
| | prototype manufacturing, QA | facilities and resources to support business operations at this level. |
| | and ongoing regulatory | Technical Capacity: Sufficient R&D staff and resources to conduct |
| | interactions for product | and oversee translational research program at this level. Substantial |
| | category (e.g. for a biotech | capability in quality-assured manufacturing of advanced versions of |
| | application, complete business | prototype product, capability to oversee validated testing of |
| | capacity to support | advanced prototype products. |
| | manufacturing of material and | Financial Capacity: Sufficient cash on hand and/or investment |
| | Phase 2 clinical trials) | commitments to enable continuous operations. |
| 8 | Capacity to support pre- | Operational Capacity: Sufficient business and operational staff, |
| | production manufacturing, | facilities and resources to support business operations at this level. |
| | quality assurance and ongoing | Sales, delivery and support capabilities beginning to develop. |
| | regulatory interactions (e.g. | Technical Capacity: Sufficient R&D staff and resources to conduct |
| | for a biotechnology | and oversee translational program at this level. Substantial |
| | application, complete business | capability in quality-assured manufacturing of advanced pre- |
| | capacity to support Phase 3 | production prototype product, capability to oversee validated testing |
| | clinical trials) | of advanced pre-production prototype products. |
| | | Financial Capacity: Sufficient cash on hand and/or investment |
| | | commitments to enable continuous operations. |
| 9 | Capacity to support delivery, | Operational Capacity: Sufficient business and operational staff, |
| | sales, maintenance and life- | facilities and resources to support business operations at this level. |
| | cycle support of post- | Complete integrated sales, delivery and support capabilities. |
| | production prototype products | Technical Capacity: Sufficient technical, production-capable staff |
| | and marketed products (e.g. | and resources to conduct and oversee translational/production |
| | for a biotechnology | program at this level. Complete integrated technical capability to |
| | application, comprehensive | support delivery, maintenance and lifecycle of full production |
| | business capacity to support | products. |
| | Phase IV post-approval studies | Financial Capacity: Sufficient cash on hand and/or investment |
| | and patient delivery/sale of | commitments to enable continuous operations. |
| | approved medical product) | |

### Deal Engine: Inputs And Processing

An example is provided below with respect to inputs to a deal engine 110 according to one or more embodiments, and the processings performed by the deal engine 110. Tables 3A, 3B and 3C below shows example inputs to a deal engine 110 according to one or more embodiments.

TABLE 3A
Inputs to Deal Engine - Project Funding Organization Inputs

| Funder ID | Biomedical funding organization 1 | |
|---|---|---|
| | (early development) | |
| Desired product profile | Broad-spectrum antimicrobial drug | |
| Scientific criteria for entry | 4 | Minimum starting TRL |
| Maximum development level | 6 | Will not fund beyond this |
| | | TRL |
| Funding amount | $30,000,000 | |
| Financing terms | Commercial | |
| | contract | |
| Funding link | Committed within TRL range | |
| Advance Market Commitment | No | |
| Funder ID | Biomedical funding organization 2 | |
| | (advanced development) | |
| Desired product profile | Broad-spectrum antimicrobial drug | |
| Scientific criteria for entry | 6 | Minimum starting TRL |
| Maximum development level | 8 | Will not fund beyond this |
| | | TRL |
| Funding amount | $50,000,000 | |
| Financing terms | Commercial | |
| | contract | |
| Funding link | Committed | |
| Advance Market Commitment | No | |
| Funder ID | Biomedical funding organization 3 | |
| | (end-user) | |
| Desired product profile | Broad-spectrum antimicrobial drug | |
| Scientific criteria for entry | 8 | Minimum starting TRL |
| Funding amount | $70,000,000 | |
| Financing terms | Commercial | |
| | contract | |
| Funding link | Committed | |
| Advance Market Commitment | $112,000,000 | plus cost of goods |

TABLE 3B
Inputs to Deal Engine - Research Organization Inputs

| Research | Biotech | | |
|---|---|---|---|
| Organization ID | Company | | |
| Proposed product | Broad-spectrum antimicrobial | | |
| profile | drug | | |
| Proof-of-concept | TRL 4 achieved | | |
| data | | | |
| Proffers | 10% co-investment at each project stage, if | | |
| | Advance Market Commitment and Funding Links | | |
| | committed | | |
| Requested financing | Commercial | | |
| terms | contract | | |
| Pathable project | | | |
| summary | | | |
| | | | Technology Level |
| | Duration | | upon completion |
| Description | (years) | Cost | of stage |
| Advanced preclinical | 1 | $10,000,000 | 5 |
| research | | | |
| Phase 1 clinical trial | 1 | $10,000,000 | 6 |
| Phase 2a clinical trial | 1 | $15,000,000 | 7 |
| Phase 2b clinical trial | 1 | $25,000,000 | 8 |
| Phase 3a clinical trial | 1.5 | $75,000,000 | 8 |
| Phase 3b clinical trial | 1.5 | $75,000,000 | 9 |

TABLE 3C
Inputs to Deal Engine: Facilitator Inputs

| Facilitator ID | Investment fund | |
|---|---|---|
| Proposed role | Co-investment | |
| Proffers | 20% | co-investment at each project stage, up to NPV of |
| | | Advance Market Commitment |
| | 15% | discount rate |
| Requirements | Commercial | |
| | contract | |
| | Advance Market Commitment committed | |
| | Funding Links committed | |
| | 70% | R&D funding from Product Funding |
| | | Organizations at each stage |
| | 10% | co-investment from Research Organization at |
| | | each stage |

| | |
|---|---|
| | Repayment of investment as share of Advance Market |
| | Commitment, proportional to co-investment by Research |
| | Organization |
| Facilitator ID | Economic development agency |
| Proposed role | Conduit bond |
| | issuer |
| Proffers | 5% interest rate probable |
| Requested | Commercial |
| financing terms | contract |

Table 4 below shows an example of project stage calculations performed by a deal engine according to one or more embodiments. In this example, there are six (6) project stages.

TABLE 4
Example of Project Stage Calculations Performed by Deal Engine
Project Stage Calculations:

| 1 | | | | | |
|---|---|---|---|---|---|
| Advanced | 2 | 3 | 4 | 5 | 6 |
| preclinical | Phase 1 clinical | Phase 2a | Phase 2b | Phase 3a | Phase 3b |
| research | trial | clinical trial | clinical trial | clinical trial | clinical trial |
| 1 | 1 | 1 | 1 | 1.5 | 1.5 |
| $10,000,000 | $10,000,000 | $15,000,000 | $25,000,000 | $75,000,000 | $75,000,000 |
| 4 | 5 | 6 | 7 | 8 | 8 |
| 5 | 6 | 7 | 8 | 8 | 9 |
| TRUE | TRUE | TRUE | TRUE | TRUE | TRUE |
| Biomedical | Biomedical | Biomedical | Biomedical | Biomedical | Biomedical |
| funding | funding | funding | funding | funding | funding |
| organization 1 | organization 1 | organization 1 | organization | organization | organization |
| (early | (early | (early | 2 (advanced | 2 (advanced | 3 (end-user) |
| development) | development) | development) | development) | development) | |
| Committed | Committed | Committed | Committed | Committed | Committed |
| within TRL | within TRL | within TRL | | | |
| range | range | range | | | |
| Biomedical | Biomedical | Biomedical | Biomedical | Biomedical | Not |
| funding | funding | funding | funding | funding | applicable |
| organization 1 | organization 1 | organization 2 | organization | organization | |
| (early | (early | (advanced | 2 (advanced | 3 (end-user) | |
| development) | development) | development) | development) | | |

In Table 4, the first row corresponds to a Project Stage Number, the second row corresponds to a Project Stage Description, the third row corresponds to a Project Stage Duration, the fourth row corresponds to a Project Stage Cost, the fifth row corresponds to a Technology Level at Start of Project Stage, the sixth row corresponds to a Technology Level at End of Project Stage, the ninth row corresponds to a Match to Funding Organization (True or False), the tenth row corresponds to a Funder for Stage, the twelfth row corresponds to a Funding Link Committed for Next Stage, and the thirteenth row corresponds to a Funder for Next Stage.

Continuing with the above example, the deal engine then performs a project continuity test to determine whether there is continuity with respect to funding of the various stages of a project, which in this case is shown below in Table 5.

TABLE 5
Example of Project Continuity Test Performed by Deal Engine:

| | |
|---|---|
| PROJECT CONTINUITY TEST | TRUE |

Continuing with the above example, the deal engine then performs financial calculations, and in this example that is shown below in Table 6 for a six stage project (each stage is represented by a separate column in Table 6):

TABLE 6
Example of Financial Calculations Performed by Deal Engine

| | | | | | | |
|---|---|---|---|---|---|---|
| $112,000,000 | | | | | | Row 1 |
| TRUE | | | | | | Row 2 |
| v | | | | | | Row 3 |
| 7 | | | | | | Row 4 |
| 15% | | | | | | Row 5 |
| $42,104,948.47 | | | | | | Row 6 |
| | | | | | | Row 7 |
| $210,000,000 | | | | | | Row 8 |
| 20.05% | | | | | | Row 9 |
| | | | | | | Row 10 |
| | | | | | | Row 11 |
| | | | | | | Row 12 |
| | | | | | | Row 13 |
| $10,000,000 | $10,000,000 | $15,000,000 | $25,000,000 | $75,000,000 | $75,000,000 | Row 14 |
| 70% | 70% | 70% | 70% | 70% | 70% | Row 15 |
| 20% | 20% | 20% | 20% | 20% | 20% | Row 16 |
| 10% | 10% | 10% | 10% | 10% | 10% | Row 17 |
| | | | | | | Row 18 |
| $7,000,000 | $7,000,000 | $10,500,000 | $17,500,000 | $52,500,000 | $52,500,000 | Row 19 |
| $2,000,000 | $2,000,000 | $3,000,000 | $5,000,000 | $15,000,000 | $15,000,000 | Row 20 |
| $1,000,000 | $1,000,000 | $1,500,000 | $2,500,000 | $7,500,000 | $7,500,000 | Row 21 |
| | | | | | | Row 22 |
| $40,104,948.47 | $38,104,948.47 | $35,104,948.47 | $30,104,948.47 | $15,104,948.47 | $104,948.47 | Row 23 |
| | | | | | | Row 24 |
| $42,000,000 | | | | | | Row 25 |
| $21,000,000 | | | | | | Row 26 |
| 2 | | | | | | Row 27 |
| | | | | | | Row 28 |
| $74,666,667 | | | | | | Row 29 |
| $37,333,333 | | | | | | Row 30 |
| | | | | | | Row 31 |
| 37.50% | | | | | | Row 32 |

In Table 6, the first row corresponds to an Advance Market Commitment Amount, the second row corresponds to an AMC Committed, the fourth row corresponds to a Baseline project duration, the fifth row corresponds to a Co-investment discount rate, the sixth row corresponds to a NPV (Net Present Value) of AMC for co-investment, the eighth row corresponds to a Baseline project cost, the ninth row corresponds to an Overall co-investor share (maximum), the twelfth row corresponds to a Funding by project stage, the fourteenth row corresponds to a Baseline stage cost, the fifteenth row corresponds to a Funder share, the sixteenth row corresponds to a Co-investor share, the seventeenth row corresponds to a Research organization share, the nineteenth row corresponds to a Funder amount, the twentieth row corresponds to a Co-investment amount, the twenty-first row corresponds to a Research organization amount, the twenty-third row corresponds to a Co-investment NPV remaining, the twenty-fifth row corresponds to a Total co-investment, the twenty-sixth row corresponds to a Total research organization investment, the twenty-seventh row corresponds to a Co-investor ratio, the twenty-ninth row corresponds to a Co-investor return from AMC, the thirtieth row corresponds to a Research Organization return from AMC, and the thirty-second row corresponds to a Ratio of co-investment to AMC.

In Table 6, the AMC Committed logic value (True, Row 2) is determined based on whether the Advance Market Commitment amount is greater than zero (which it is in this example). The Baseline Project Duration (Row 4) is the sum of the Project Stage Durations (see Table 4). The NPV of AMC for Coinvestment value (Row 6, $42,104,948.47) corresponds to the NPV of the Commitment Amount value (Row 1, $112,000,000) at the Coinvestment Discount Rate (Row 5, 15%). The Baseline Project Cost value (Row 8) is the sum of the Project Stage Costs (see Table 4). The Coinvestment DMV Remaining value (Row 23) is calculated as the NPV of AMC for Coinvestment value ($2,104,948.47) minus the Coinvestment Amount for a particular stage. The Coinvestor ratio (Row 27) is calculated as the Total Coinvestment value divided by the Total Research Organization Investment value. The Coinvestor Return for AMC value (Row 29) is calculated as the Advance Market Commitment amount multiplied by {(Coinvestor ratio)/(Coinvestor ratio+1)}. The Research Organization Return from AMC value (Row 30) is calculated as the Advance Market Commitment amount divided by (Coinvestor ratio+1). Lastly, the Ratio of Coinvestment to AMC (Row 32) is calculated as Total Coinvestment divided by Advance Market Commitment amount.

Based on the example shown in Table 6, for the entire six project stages, the total funding is: $147,000,000 funder amount, $42,000,000 coinvestment amount, and $21,000,000 research organization amount.

In some embodiments, the deal engine may analyze the proposed project in comparison to traditional government contracting, and provide a report with such comparison analysis to investors and R&D companies seeking funds from investors. Table 7 below shows an example of this analysis, for a deal engine according to some embodiments. In the example shown in Table 7, due to the innovative financing techniques proposed by the deal engine, there is much less financing needed from investors to fund a project based on the deal proposed by the deal engine (in this case, about $86,000,000 less funding needed).

TABLE 7
Comparison of Proposed Project to Traditional
Government Contracting

| | | |
|---|---|---|
| Project stages | 6 | |
| Project funders | 3 | |
| Links between funders | 2 | |
| Estimated time delay for traditional | | |
| contracting | | |
| Proposal cycle duration | 1 | |
| Project delay due to proposal cycles | 2 | |
| Additional non-project costs | | |
| Business development cost % | 5% | Estimated |
| | | average |
| Non-project administrative costs | 5% | Estimated |
| | | average |
| Total additional costs | $21,000,000 | |
| Fee rate on non-project costs | 10% | |
| Fee on non-project costs | $2,100,000 | |
| Total additional cost plus fee | $23,100,000 | |
| Total contribution of funding organizations if | $233,100,000 | |
| project performed under traditional | | |
| contracting | | |
| Total contribution of funding organizations | $147,000,000 | |
| under innovation finance approach | | |
| Savings of innovation finance approach | $86,100,000 | |

In Table 7, the Links Between Funders value is calculated as the Project Funders value minus 1. The Project Delay Due to Proposed Cycles value is calculated as the Links Between Funders value multiplied by the Proposed Cycle Duration value. The Total Additional Costs value is calculated as the Business Project Cost value (see Table 6) multiplied by (Business Development Cost+Non-project Administrative Cost). The Total Contribution of Funding Organizations if Project Performed Under Traditional Contracting value is calculated as the Baseline Project Cost value plus the Total Additional Costs Plus Fees value. The Total contribution of funding organizations under innovation finance approach value is calculated as the sum of the Funder Amounts for each of the project stages.

Also, the deal engine according to one or more embodiments may perform bond calculations for possible financing of various stages of a project. An example of such bond calculations is provided below, with reference to Table 8.

TABLE 8
Deal Engine Bond Calculation Example

Funding agency 1 (early development) elects to pay cash for its
R&D contribution of $24,500,000 over 3 years
Funding agency 2 (advanced development) must make an R&D
contribution of $70,000,000. The agency elects to deliver the
money via a 7-year bond.
The bond calculations are shown for Funding agency 2.
Funding agency 3 is not considered in this scenario. It could
deliver its R&D contribution as cash or via a bond.

| Uses Of Funds | | |
|---|---|---|
| Project costs | $70,000,000 | |
| Debt service reserve fund | $8,000,000 | 10% of Funds |
| Estimated issuance expenses | $2,000,000 | Includes placement |
| | | agent fees, legal |
| | | counsel, financial |
| | | advisory, conduit |
| | | issuer fees, trustee |
| | | fees, etc. |
| Total uses of funds | $80,000,000 | |
| Sources Of Funds | | |
| Bond proceeds | $80,000,000 | |
| Approximate bond terms | | |
| Estimated interest rate | 5.500% | Example rate |
| Amortization term | 7 | Years |
| Estimated annual debt service | $14,077,153 | |
| Less earnings on Debt Service | $40,000 | |
| Reserve fund @0.50% | | |
| Net annual debt service | $14,037,153 | |
| Total Outlay by Funding agency 2 | $90,260,074 | |

In this scenario, for Stages 4 and 5 of
the project,
the R&D work is performed in 2.5 years, following the
science schedule.
The Co-investor and the Research Organization contribute their
funds at the start of Stage 4
Funding agency 2 contributes its funds as debt service over
7 years, paying $14,037,153 per year
and allowing it to stretch out and smooth
its cash flow.

For the above example, for stages 4 and 5 of the project, the R&D work is performed in 2.5 years, following the science schedule. The co-investors contribute and the Research Organization contribute their funds at the start of stage 4, the funding agency 2 contributes its funds as debt service over 7 years, paying $14,037,153 per year, thereby allowing it to stretch out and smooth its cash flow.

In Table 8, the project cost value of $70,000,000 is calculated as a sum of the funder amounts $17,500,000 and $52,500,000 in the financial calculations performed by the deal engine (see Table 6). The “bond proceeds” value corresponds to the total uses of funds value of $80,000,000. The “estimated annual debt service” value of $14,077,153 is calculated based on the 5.5% interest rate, the 7 year amortization term, and the $80,000,000 bond proceeds (debt) amount. The “less earnings on debt service reserve fund @0.50%” value of $40,000 is calculated as 0.005*the debt services reserve fund value of $8,000,000. The “net annual debt service” value of $14,037,053 is calculated as the “estimated annual debt service” value minus the “less earnings on debt service reserve fund” value. Lastly, the “total outlay by funding agency” value of $90,260,074 is calculated as the “net annual debt service” value (14,037,153) multiplied by the “amortization term” value (7), minus the “debt service reserve fund” value (8,000,000).

Based on the above example, the deal engine according to one or more embodiments provides information that is very useful in determining whether or not investors should invest in various stages of projects that request funding, and that provides the tools for both investors and R&D companies to contract with each other and to find the appropriate financing for all stages of a project.

### Deal Engine: Risk Index

In some embodiments, an Innovation Finance Risk Index (IFRI) may be obtained based at least in part on IFRI factors. The IFRI Factors may be computed based on: a) TRLs, b) Business Readiness Level (BRL), and c) Financial (or Capital) Readiness Level (F/CRL). In more detail, F/CRL=(Amount of Federally-provided (or other-entity-provided)Capital)/(Total Capital Required to Complete the Project).

IFRI may then be computed in some embodiments as: IFRI=TRL*BRL*F/CRL.

In other embodiments, IFRI is computed as: IFRI=TRL+BRL+F/CRL. In either implementation, a larger IFRI value signifies a lesser financial risk assessment for a particular product to be considered for funding, and vice versa.

In some embodiments, each of the factors used to compute IFRI may be benchmarked to external comparables data sets based on and extrapolated from publicly available public and private sector funding and financing data, in which each of the factors can be updated periodically, such as monthly, quarterly, or annually.

Based on the computed IFRI, investors may determine whether or not a particular research and development for which funding is requested by a particular entity, for one or more research and development stages poses an acceptable risk to those investors.

Examples as to how IFRI may be computed according to some embodiments are provided below.

IFRI=f({P}), where {P} is a set of input parameters. In some embodiments, {P} can be the set of input parameters TRL, BRL, Capital Committed, and Capital Required to Project Completion. TRL is the project's Technology Readiness Level, which may range in some embodiments from a value of 1 up to a maximum value TRLₘₐₓ (see Table 1, whereby in that example TRLₘₐₓ is 9). BRL is the Business Readiness Level of the organization conducting the project, which may range in some embodiments from a value of 1 up to a maximum value BRLₘₐₓ (e.g., BRLₘₐₓ=9). Capital Committed is the amount of capital committed from various sources to perform the project, and may be expressed as a monetary value. Capital Required to Project Completion is the amount of capital estimated to be needed to complete the project from its current state.

Financial Readiness Level, or FRL, is a parameter that may be calculated according to the following expression:

FRL=100%*(Capital Committed/Capital Required to Project Completion)

With the above input parameters, in one embodiment, IFRI can be calculated as:

IFRI=3−(K1*(TRL/TRLₘₐₓ)+(K2*(BRL/BRLₘₐₓ)+K3*FRL)), where

K1 is a Technology Readiness Weighting Factor that can be assigned as a nominal value of 1 or that can be set to a fractional value between 0 and 1 as determined from past technology readiness performance data of a selected set of previous projects,

K2 is a Business Readiness Weighting Factor that can be assigned as a nominal value of 1 or that can be set to a fractional value between 0 and 1 as determined from past business readiness performance data of a selected set of previous projects,

K3 is a Finance Readiness Weighting Factor that can be assigned as a nominal value of 1 or that can be set to a fractional value between 0 and 1 as determined from past finance readiness performance data of a selected set of previous projects.

Using the above function f, and an example set of parameter and weighting factors, IFRI can be calculated for an example project as follows:

TRLₘₐₓ=9,

BRLₘₐₓ=9

K1=1,

K2=1,

K3=1

### Project 1: TRL=5, BRL=4, Capital Committed=$50,000,000, Capital Required to Project Completion=$300,000,000, FRL=100*(50,000,000/300,000,000)=16.67%

### Project 2: TRL=1, BRL=2, Capital Committed=$1,000,000; Capital Required to Project Completion=$300,000,000, FRL=100*(1,000,000/300,000,000)=0.33%

### Project 3: TRL=3, BRL=3, Capital Committed=$5,000,000; Capital Required to Project Completion=$300,000,000, FRL=100*(5,000,000/300,000,000)=1.67%

### Project 4: TRL=6, BRL=2, Capital Committed=$15,000,000; Capital Required to Project Completion=$300,000,000, FRL=100*(15,000,000/300,000,000)=5.00%

### Project 5: TRL=7, BRL=5, Capital Committed=$100,000,000; Capital Required to Project Completion=$250,000,000, FRL=100*(100,000,000/250,000,000)=40.00%

### Project 6: TRL=8, BRL=8, Capital Committed=$250,000,000; Capital Required to Project Completion=$300,000,000, FRL=100*(250,000,000/300,000,000)=83.33%

From the above data, IFRI can be computed for the six projects to be: IFRI for Project 1=1.833, IFRI for Project 2=2.663, IFRI for Project 3=2.317, IFRI for Project 4=2.061, IFRI for Project 5=1.267, and IFRI for Project 6=0.389.

In some embodiments, using the form of the IFRI function as described above, IFRI can take on a value from zero to three, with zero equaling the lowest risk and three indicating the highest risk. Thus, in the above examples, Project 6 has the lowest risk and Project 2 has the highest risk.

In some embodiments, using the form of the IFRI function as described above, the Technology Readiness Level, Business Readiness Level, and Financial Readiness Level are given equal weight in calculating the risk, but this need not necessarily always be the case (e.g., the weighting may be empirical, based on past performance data that may affect the weightings K1, K2, K3).

The computed value IFRI, which corresponds to the risk index for a project, may be used in some embodiments to select a preferred project for funding from a set of projects. In the above examples, based on the amount of risk that an investor may wish to take, the investor may choose to invest in Project 6 if the investor is not willing to take on much risk, and the investor may choose to invest in Project 2 and/or Project 3 if the investor is willing to take on much risk.

In other embodiments, using for example empirical values for the weighting factors K1, K2, K3, based on various analyses of various sets of historical data from actual performance of historical projects, the weights of the Technology Readiness, Business Readiness, and Financial Readiness factors K1, K2, K3 may be different, which will affect the computation of IFRI.

In addition, analyses of the empirical data on historical projects for various different industry sectors may be used to indicate that each industry sector has its own sector-specific weighting factors K1, K2, K3, indicating different relative weights of the importance of the Technology Readiness, Business Readiness, and Financial Readiness aspects in different industries.

In some embodiments, IFRI may be calculated using other functions f. For example, in some embodiments, IFRI may be computed using Step functions, where the output f({P}) is defined by values enumerated by a user.

In other embodiments, IFRI may be computed using Probabilistic functions, where the output f({P}) is given not as a single value but as a probability distribution for risk based on the input parameters such as TRL, BRL, and FRL, and it either may be calculated from sets of values or may be provided from a table of empirically encountered probability distributions based on historical data.

In yet other embodiments, IFRI may be computed using non-linear functions, where the output f({P}) is calculated using non-linear functions of the input parameters {P}, such as polynomial functions, exponential functions, power-law functions, integral or derivative functions.

In other embodiments, IFRI may be computed using Composite functions, where the input parameters {P} are themselves functions of other sets of subparameters {Q}.

In yet other embodiments, IFRI may be computed using another mathematically valid function or combination of functions.

Additional embodiments for computing IFRI can use Commitment Risk Factors to evaluate the reduction of risk of a project if an Advance Market Commitment and Funding Links are made. An example of computing IFRI using Commitment Risk Factors is described below, which uses elements of commitment by one or more product funding organizations to compute reduction in risk as linked funding commitments are made.

Example for Computing IFRI Using Commitment Risk Factors:

IFRI=f({P}), where {P} is a set of input parameters.

In this example, {P} may comprise the following set of input parameters: AMC Committed, AMC Amount, Project Stages, Funding Link Committed, Funding Link Amounts, TRL, BRL, Capital Committed, and Capital Required To Project Completion, where:

a) AMC Committed is a fuzzy boolean parameter (true/false, or fuzzy values in between), indicating whether a Product Funding Organization has made a binding Advance Market Commitment to purchase products which reach approval for use,
b) AMC Amount is the amount of the binding Advance Market Commitment,
c) Project Stages is the number of stages in the project, d) Funding Link Committed is an array of fuzzy boolean parameters, with one value per stage of the project, indicating whether a Product Funding Organization has made a binding commitment to fund the next stage of the project,
e) Funding Link Amounts is an array of currency values, with one value per stage of the project, indicating the amount committed to the link from each stage of the project to the next stage,
f) TRL is the project's Technology Readiness Level, ranging from 1 to a maximum, denoted as TRLₘₐₓ (e.g., TRLₘₐₓ=9),
g) BRL is the Business Readiness Level of the organization conducting the project, ranging from 1 to a maximum, denoted as BRLₘₐₓ (e.g., BRLₘₐₓ=9), h) Capital Committed is the amount of capital committed from various sources to perform the project,
i) Capital Required To Project Completion is the amount of capital estimated to be needed to complete the project from its current state, and
j) FRL is the Financial Readiness Level and is a calculated parameter, calculated as 100%*(Capital Committed/Capital Required To Project Completion).

With these input parameters, as one example IFRI can be calculated as:

IFRI=AMC Committed*Funding Link 1*Funding Link 2*(K1*(TRL/TRLₘₐₓ)+K2*(BRL/BRLₘₐₓ)+K3*FRL)), where

K1 is a Technology Readiness Weighting Factor which may be assigned a nominal value of 1 or can be determined from past performance data of a selected set of previous projects,
K2 is a Business Readiness Weighting Factor which may be assigned a nominal value of 1 or can be determined from past performance data of a selected set of previous projects, and
K3 is a Finance Readiness Weighting Factor which may be assigned a nominal value of 1 or can be determined from past performance data of a selected set of previous projects.

Using this function f, and an example set of parameter and weighting factors, IFRI can be calculated for an example project as follows:

| AMC Committed | 1 (true) |
|---|---|
| Project Stages | 2 |
| Funding Link Committed 1 | 1 (true) |
| Funding Link Committed 2 | 1 (true) |
| TRLmax | 9 |
| BRLmax | 9 |
| K1 | 1 |
| K2 | 1 |
| K3 | 1 |

| | | | | | | | | Capital |
|---|---|---|---|---|---|---|---|---|
| | | | | | | | | Required To |
| | AMC | Project | Funding Link | Funding Link | | | Capital | Project |
| | Committed | Stages | Committed 1 | Committed 2 | TRL | BRL | Committed | Completion |
| Project 1 | 1 | 2 | 1 | 1 | 5 | 4 | $50,000,000 | $300,000,000 |

Based on the above numbers, IFRI may be calculated for a set of projects as follows:

| | | | | | | | | Capital |
|---|---|---|---|---|---|---|---|---|
| | | | | | | | | Required To |
| | AMC | Project | Funding Link | Funding Link | | | Capital | Project |
| | Committed | Stages | Committed 1 | Committed 2 | TRL | BRL | Committed | Completion |
| Project 1 | 1 | 2 | 1 | 1 | 5 | 4 | $50,000,000 | $300,000,000 |
| Project 2 | 1 | 2 | 1 | 1 | 1 | 2 | $1,000,000 | $300,000,000 |
| Project 3 | 0 | 2 | 1 | 1 | 3 | 3 | $5,000,000 | $300,000,000 |
| Project 4 | 1 | 2 | 1 | 1 | 6 | 2 | $15,000,000 | $300,000,000 |
| Project 5 | 1 | 2 | 1 | 0 | 7 | 5 | $100,000,000 | $250,000,000 |
| Project 6 | 0 | 2 | 1 | 1 | 8 | 8 | $250,000,000 | $300,000,000 |

In this manner of computing the IFRI function according to some embodiments, IFRI may take on a value from zero to three, with zero equaling the highest risk and three indicating the lowest risk.

Note that examples have been provide of pharmaceutical and biotech research and development and products, but the invention is not so limited. The invention may be applied for generating a series of sub-matches and partial sub-matches for any type of product or research and development.

### Deal Engine Generation of Draft Deal Documents

As described earlier, and referring to FIGS. 1A and 8A, the deal engine according to some embodiments creates and outputs draft master contracts and all sub-contracts are generated by the system from standard contract templates stored in the system 100 and provided to the parties' legal representatives for review. An example of such draft documents output by the deal engine is described below, whereby these are indicative types and/or titles of documents generated by the system according to some embodiments. Note that the actual text of the documents may vary and is not shown in the example below. The database 120 shown in FIG. 1A may store a wide variety of standard templates, clauses, etc., to create and output a document set to suit various types of deals created by the deal engine. Table 9 below shows documents that may be created and output by a deal engine for a particular deal created by the deal engine.

TABLE 9
Deal Document Set Output by Deal Engine

| | |
|---|---|
| Term Sheet | Summary/synopsis of the deal and its terms |
| Project Master | Master agreement defining the overall framework for the project. |
| Agreement | All the other agreements are performed within the framework |
| | of the Project Master Agreement |
| Advance Market | Agreement specifying the Advance Market Commitment, |
| Commitment | science criteria, exercise terms, change terms, commitment amount, |
| Agreement | termination conditions and amounts |
| Funding Link | Agreements among Product Funding Organizations specifying the |
| Agreements | terms for linked funding of the project stages, e.g. science criteria, |
| | exercise terms, change terms, commitment amount, termination |
| | conditions and amounts |
| Research Organization | Agreement specifying the terms of the Research Organization(s)' |
| Investment Agreement | investments in the project, e.g. amounts, funding schedule, exercise |
| | conditions |
| Co-Investment | Agreement specifying the terms of co-investors' investments in the project, |
| Agreement | e.g. amounts, funding schedule, exercise conditions, change terms, |
| | termination conditions, |
| Funding Agreements | Agreements among the project participants specifying the terms for |
| | funding of individual project stages by Product Funding Organizations, |
| | e.g. science criteria, milestone schedule, funding amounts, change terms, |
| | termination conditions and amounts, provision of funds as cash or |
| | debt service, etc. |
| Debt Finance | Agreements used if the project participants have decided that one or |
| Agreements | more elements of the project will be supported by debt financing |
| | (i.e., if some of the Funding Agreements indicate that funds will be |
| | provided as debt service on bonds) |
| Product Development | Agreement defining the overall research and development path to bring |
| Agreement | the product to approval. Additional subagreements define individual |
| | stages of the product development path. |
| Project Draw Schedule | Schedule defining the funding payment schedule, milestones and milestone |
| | criteria, etc. |
| Supporting | Agreements among the project participants and/or other parties specifying |
| Agreements | any additional supporting resources, activities, etc. as needed to enable |
| | the project to be performed. These may include insurance agreements, |
| | performance and/or quality sureties, additional investment agreements, etc. |

If debt financing such as bonds or loans is being used in a project, then the deal engine according to some embodiments may generate an additional subset of documents to support the negotiation and issuance of such debt instruments. An example of such additional subsets of documents are described below in an example, with reference to Table 10.

TABLE 10
Additional Deal Document Set Output by Deal Engine for Debt Financing:

General Certificate of Bond Issuer, including Exhibits (e.g. enabling act, inducement resolution, bond
resolution, public notice certificates, approval certificates)
Bond application
Confirmation of issuance
Proceedings of Borrower
General Certificate of Borrower, including Exhibits (e.g. Certificate of Formation, Operating Agreement,
Board of Directors' Resolutions, Certificate of Good Standing)
Bond Placement Agreements, including bond data such as par value, tax status, securities registration
information, information on legal counsel to the parties, issuer documentation, liability disclaimers,
summary of key funding agreements, statement of sources and uses of funds, security arrangements,
assignments of funding agreements, interest and principal payment dates, extraordinary redemption
provisions, call/put features, bond delivery information, disclosures and disclosure agreements, legal
opinions, etc.
Bond Documents, e.g. indenture of trust, certificates and opinions, authorization, execution, transfer,
exchange agreements, waivers, and all other documents necessary for the issuance of the bonds
Loan Agreements, Promissory Notes, Representations, Assignments, Sureties
Closing Papers, e.g. Certificate of Trustee, Certificate of Placement Agent, Receipts for Bonds and
Bond Proceeds, etc.

Embodiments within the scope of the present invention include program products comprising machine-readable media for carrying or having machine-executable instructions or data structures stored thereon. Such machine-readable media may be any available media which may be accessed by a general purpose or special purpose computer or other machine with a processor. By way of example, such machine-readable media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions. Note that the machine-executable instructions/programming code may comprise algorithms embedded in Excel or other spreadsheets.

Embodiments of the invention have been described in the general context of method steps which may be implemented in embodiments by a program product including machine-executable instructions, such as program code, for example in the form of program modules executed by machines in networked environments. Generally, program modules include routines, programs, objects, components, data structures, etc., that perform particular tasks or implement particular data types. Multi-threaded applications may be used, for example, based on Java or C++. Machine-executable instructions, associated data structures, and program modules represent examples of program code for executing steps of the methods disclosed herein. The particular sequence of such executable instructions or associated data structures represent examples of corresponding acts for implementing the functions described in such steps. As noted, the machine-executable instructions/programming code may comprise algorithms embedded in Excel or other spreadsheets.

Embodiments of the present invention may be practiced with one or multiple computers in a networked environment using logical connections to one or more remote computers (including mobile devices) having processors. Logical connections may include a local area network (LAN) and a wide area network (WAN) that are presented here by way of example and not limitation. Such networked environments are commonplace in office-wide or enterprise-wide computer networks, and include intranets and the Internet, and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired and wireless links) through a communications network. In a distributed computing environment, program modules may be located in both local and remote memory storage devices.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with programming techniques with rule based logic and other logic to accomplish the various database searching steps, correlation steps, comparison steps and decision steps. Artificial intelligence tools, such as inference, neural network logic, and other tools known to one of skill in the art may be used to accomplish searching, calculating, matching, or other computational steps. It should also be noted that the word “component” as used herein and in the claims is intended to encompass implementations using one or more lines of software code, and/or hardware implementations. It should also be noted that the phrase “a plurality” is intended to mean more than one, and is not intended to refer to any previous recitation of the word “plurality,” unless preceded by the word “the.”

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

We claim:

1. A method comprising:
accessing, using one or more computers, one or more databases on computer-readable storage media, comprising:
research and development organizations;
product development projects associated with respective of the research and development organizations;
funding organizations, and respective organization funding requirements including a technical readiness requirement for the respective product development project;
securities issuing entities, and respective issuing entity requirements;
securities purchasing entities with one or more securities purchase criteria;
pathable development projects, wherein a respective pathable project comprises a project with a timeline or path that comprises a plurality of development stages and milestones related to the development of a marketable product from one of the product development projects;
obtaining and storing over time, using the one or more computers, data for product development projects, research and development organizations; funding organizations, and respective organization requirements; securities issuing entities, and respective issuing entity requirements, securities purchasing entities, and pathable development projects;
determining or obtaining a respective technical readiness level for each of a plurality of the product development projects and storing, using the one or more computers, the respective technical readiness levels in the one or more databases;
determining or obtaining for each of a plurality of the product development projects, respective development stages and milestones for a respective pathable development project and one or more entities to perform the respective development stages;
determining, using the one or more computers, an estimated full or partial funding amount for respective of the pathable development projects;
determining in one or more matching steps one or more of:
matching, using the one or more computers, a respective one of the pathable development projects with one or more of the funding organizations, based at least in part on matching the organization requirements of the respective funding organization to one selected from the group of the technical readiness level of the product development project associated with the respective pathable development project, a target product profile, an amount of available funds for a given target product profile, an approximate timeframe for completion of the pathable development project, and a requested co-funding amount;
matching, using the one or more computers, one or more of the funding organizations with one or more of the securities issuing entities, based at least in part on the respective issuing entity requirements of the respective issuing entities relating to at least one selected from the group of jobs projected to be created by the respective pathable development project, location of work for the respective pathable development project, and technology type;
matching, using the one or more computers, one or more of the securities issuing entities with one or more of the pathable development projects, based at least in part on one selected from the group of a projected financial return, a schedule of tranches for the stages of the pathable development project, and a surety arrangement;
matching, using the one or more computers, one or more of the securities purchasing entities with one or more of the securities issuing entities, based at least in part on at least one selected from the group of level or percentage of funding relative to the funding amount for the respective pathable development project, a projected financial return, a schedule of tranches for the stages of the pathable development project, and a surety arrangement; and
determining, using the one or more computers, that a level or percentage of funding of the pathable development project is substantially complete relative to the full funding amount for the respective pathable development project or determining a gap in the level or percentage of funding of the pathable development project relative to the full funding amount for the respective pathable development project.

2. The method according to claim 1, further comprising:
publishing to at least selected entities data relating to the pathable development project that has substantially complete funding and/or publishing results of individual matching steps; and
generating and sending tranche data, using the one or more computers, for a respective one of the pathable development projects, to the one or more entities that are to perform the development stages for the respective pathable development project.

3. The method according to claim 1, wherein the product development projects comprise pharmaceutical and/or biotechnological product development projects.

4. The method according to claim 1, further comprising:
calculating, using the one or more computers, and making available to at least the selected entities, an Innovation Finance Risk Index (IFRI) and IFRI Factors (IFRI Factors), comprising (1) a Technology Readiness Factor (TRF) based on and tied to standard TRLs; (2) a Business Readiness Factor (BRF) based on and tied to standard BRLs that is determined at least in part by historical business readiness data; and (3) a Financial or Capital Readiness Level (F/CRL), wherein the F/CRL is calculated with a numerator being an amount of federal or other capital, and a denominator comprising the full funding amount required to complete the pathable development project, and with all 3 factors added or multiplied to produce a sum or product IFRI Score; and with each Factor benchmarked to Proprietary external comparables data sets based on and extrapolated from publicly available public and private sector funding and financing data; and with IFRI Scores also so benchmarked; and with all IFRI Factors, Scores, and Data Sets updated in real time and/or on a regular basis, including at least one of daily/weekly/monthly/quarterly/annually.

5. The method according to claim 1, further comprising:
calculating, using the one or more computers, a net present value of a stock or bond purchase; and
modifying the net present value of the securities purchase based in part on Monte Carlo simulation.

6. The method according to claim 1, wherein one of the funding organizations is a government entity that provides a bond payment pledge or guarantee for debt service of bonds.

7. The method according to claim 6, wherein one of the organization funding requirements is a capital investment in the product development project from an investor.

8. The method according to claim 7, further comprising:
creating a positive funding feedback loop by calculating the investment returns available to the funding organizations and the investors, and calculating an allocation of a portion of the investment returns to a pool for further funding of additional projects.

9. The method according to claim 6, wherein one of the securities issuing entities is a state or local economic development entity.

10. The method according to claim 1, wherein one of the organization funding requirements is an capital investment in the product development project from an investor.

11. The method according to claim 1, wherein one of the securities purchase criteria comprises an identification of a particular tranche for one or more of the stages of the pathable development project.

12. The method according to claim 1, further comprising:
generating, using the one or more computers, an input-output graphical-user interface for display, wherein the graphical-user interface comprises:
a product development projects list with each product development project listing one or more associated funding organizations;
a research and development organizations list; and
a deal assembly workspace that enables selection of candidate products for potential investment via an action by a user, and that enables the user to agree to a deal or to reject the deal by an action made by the user.

13. The method according to claim 1, further comprising:
generating, using the one or more computers, an input-output graphical-user interface for display, wherein the graphical-user interface comprises for each of a plurality of the product development projects:
a listing of the stage for the product development project;
for each stage a listing comprising the respective research and development organization, the one or more funding organizations, the securities issuer, the one or more securities purchasers; and fund amounts provided, committed, allocated, or pledged.

14. The method according to claim 1, further comprising:
receiving a user selection made via the input-output graphical-user interface regarding at least one of product development projects, development stages and milestones; and
performing a matching of the at least one of the product development projects with the one or more of the funding organizations.

15. The method according to claim 1, further comprising:
generating, using the one or more computers, an input-output graphical-user interface for display, wherein the graphical-user interface comprises for each of a plurality of the product development projects: a listing of unfunded stages or gaps in funding relative to the full funding amount for the respective pathable development project.

16. The method according to claim 15, further comprising:
receiving a user selection via the input-output graphical-user interface regarding the list of unfunded stages or gaps in funding; and
determining whether a match can be made with the one or more of the funding organizations for the unfunded stages of gaps.

17. The method according to claim 1, wherein at least one of the securities issuing entities is a government economic development agency that issues bonds.

18. The method according to claim 1, wherein the securities issuing entities issue stock.

19. A system comprising:
one or more databases stored on computer-readable storage media, the one or more databases storing data regarding:
research and development organizations;
product development projects associated with respective of the research and development organizations;
funding organizations, and respective organization funding requirements including a technical readiness requirement for the respective product development project;
securities issuing entities, and respective issuing entity requirements;
securities purchasing entities with one or more securities purchase criteria;
pathable development projects, wherein a respective pathable project comprises a project with a timeline or path that comprises a plurality of development stages and milestones related to the development of a marketable product from one of the product development projects; and
one or more computers that have access to the one or more databases, the one or more computers configured with computer readable code stored on a computer readable medium, that when executed, causes the one or more computers to perform the functions of:
obtaining and storing over time data for product development projects, research and development organizations; funding organizations, and respective organization requirements; securities issuing entities, and respective issuing entity requirements, securities purchasing entities, and pathable development projects;
determining or obtaining a respective technical readiness level for each of a plurality of the product development projects and storing, using the one or more computers, the respective technical readiness levels in the one or more databases;
determining or obtaining for each of a plurality of the product development projects, respective development stages and milestones for a respective pathable development project and one or more entities to perform the respective development stages;
determining or obtaining an estimated full or partial funding amount for respective of the pathable development project;
determining in one or more matching functions one or more of:
matching a respective one of the pathable development projects with one or more of the funding organizations, based at least in part on matching the organization requirements of the respective funding organization to one selected from the group of the technical readiness level of the product development project associated with the respective pathable development project, a target product profile, an amount of available funds for a given target product profile, an approximate timeframe for completion of the pathable development project, and a requested co-funding amount;
matching one or more of the funding organizations with one or more of the securities issuing entities, based at least in part on the respective issuing entity requirements of the respective issuing entities relating to at least one selected from the group of jobs projected to be created by the respective pathable development project, location of work for the respective pathable development project, and technology type;
matching one or more of the securities issuing entities with one or more of the pathable development projects, based at least in part on one selected from the group of a projected financial return, a schedule of tranches for the stages of the pathable development project, and a surety arrangement;
matching one or more of the securities purchasing entities with one or more of the securities issuing entities, based at least in part at least one selected from the group of level or percentage of funding relative to the funding amount for the respective pathable development project, a projected financial return, a schedule of tranches for the stages of the pathable development project, and a surety arrangement; and
determining a level or percentage of funding of the pathable development project is substantially complete relative to the full funding amount for the respective pathable development project or determining a gap in the level or percentage of funding of the pathable development project relative to the full funding amount for the respective pathable development project.

20. The system according to claim 19, wherein the one or more computers are configured with computer readable code stored on the computer readable medium, that when executed, causes the one or more computers to perform the functions of:
publishing to at least selected entities data relating to the pathable development project that has substantially complete funding and/or publishing results of individual matching steps; and
generating and sending tranche data for a respective one of the pathable development projects, to the one or more entities that are to perform the development stages for the respective pathable development project.

21. The system according to claim 19, wherein the product development projects comprise pharmaceutical and/or biotechnological product development projects.

22. The system according to claim 19, wherein the one or more computers are configured with computer readable code stored on the computer readable medium, that when executed, causes the one or more computers to perform the function of:
calculating and making available to at least the selected entities, an Innovation Finance Risk Index (IFRI) and IFRI Factors (IFRI Factors), comprising (1) a Technology Readiness Factor (TRF) based on and tied to standard TRLs; (2) a Business Readiness Factor (BRF) based on and tied to standard BRLs that is determined at least in part by historical business readiness data; and (3) a Financial or Capital Readiness Level (F/CRL), wherein the F/CRL is calculated with a numerator being an amount of federal or other capital, and a denominator comprising the full funding amount required to complete the pathable development project, and with all 3 factors added or multiplied to produce a sum or product IFRI Score; and with each Factor benchmarked to Proprietary external comparables data sets based on and extrapolated from publicly available public and private sector funding and financing data; and with IFRI Scores also so benchmarked; and with all IFRI Factors, Scores, and Data Sets updated in real time and/or on a regular basis, including at least one of daily/weekly/monthly/quarterly/annually.

23. The system according to claim 19, wherein the one or more computers are configured with computer readable code stored on the computer readable medium, that when executed, causes the one or more computers to perform the functions of:
calculating a net present value of securities, stock, or bond purchase; and
modifying the net present value of the securities purchase based in part on Monte Carlo simulation.

24. The system according to claim 19, wherein one of the funding organizations is a government entity that provides a bond payment pledge or guarantee for debt service of bonds.

25. The system according to claim 24, wherein one of the organization funding requirements is a capital investment in the product development project from an investor.

26. The system according to claim 22, wherein the one or more computers are configured with computer readable code stored on the computer readable medium, that when executed, causes the one or more computers to perform the function of:
creating a positive funding feedback loop by calculating the investment returns available to the funding organizations and the investors, and calculating an allocation of a portion of the investment returns to a pool for further investment in additional projects.

27. The system according to claim 19, wherein one of the one or more criteria for tranche distribution to one of the entities performing a development stage is that a predetermined one of the milestones for the pathable development project has been achieved.

28. The system according to claim 19, wherein the one or more computers are configured with computer readable code stored on the computer readable medium, that when executed, causes the one or more computers to perform the functions of:
generating, an input-output graphical-user interface for display, wherein the graphical-user interface comprises:
a product development projects list with each product development project listing one or more associated funding organizations;
a research and development organizations list; and
a deal assembly workspace that enables selection of candidate products for potential investment via an action by a user, and that enables the user to agree to a deal or to reject the deal by an action made by the user.

29. The system according to claim 19, wherein the one or more computers are configured with computer readable code stored on the computer readable medium, that when executed, causes the one or more computers to perform the function of:
generating an input-output graphical-user interface for display, wherein the graphical-user interface comprises for each of a plurality of the product development projects:
a listing of the stage for the product development project;
for each stage a listing comprising the respective research and development organization, the one or more funding organizations, the securities issuer, the one or more securities purchasers; and fund amounts provided, committed, allocated, or pledged.

30. The system according to claim 19, wherein the one or more computers are configured with computer readable code stored on the computer readable medium, that when executed, causes the one or more computers to perform the function of:
generating an input-output graphical-user interface for display, wherein the graphical-user interface comprises for each of a plurality of the product development projects: a listing of unfunded stages or gaps in funding relative to the full funding amount for the respective pathable development project.

31. The system according to claim 19, wherein the one or more computers are configured with computer readable code stored on the computer readable medium, that when executed, causes the one or more computers to perform the functions of:
receiving a user selection made via the input-output graphical-user interface regarding at least one of product development projects, development stages and milestones; and
performing a matching of the at least one of the product development projects with the one or more of the funding organizations.

32. The system according to claim 30, wherein the one or more computers are configured with computer readable code stored on the computer readable medium, that when executed, causes the one or more computers to perform the functions of:
receiving a user selection via the input-output graphical-user interface regarding the list of unfunded stages or gaps in funding; and
determining whether a match can be made with the one or more of the funding organizations for the unfunded stages of gaps.
